(19) United States
(12) Patent Application Publication
(10) Pub. No.: US 2024/0155513 A1
(43) Pub. Date: May 9, 2024

(54) UPLINK POWER BOOSTING

(71) Applicant: QUALCOMM Incorporated, San Diego, CA (US)

(72) Inventors: Sumant Jayaraman IYER, San Diego, CA (US); Gokul SRIDHARAN, Sunnyvale, CA (US)

(21) Appl. No.: 18/318,357

(22) Filed: May 16, 2023

Related U.S. Application Data
(60) Provisional application No. 63/382,699, filed on Nov. 7, 2022.

(51) Int. Cl. H04W 52/36

(52) U.S. Cl. CPC H04W 52/367; H04W 52/365

(57) ABSTRACT

Various aspects of the present disclosure generally relate to wireless communication. In some aspects, a user equipment (UE) may transmit an indication of a UE-proposed power change. The UE may transmit an uplink transmission based at least in part on the UE-proposed power change. Numerous other aspects are described.

### CROSS-REFERENCE TO RELATED APPLICATION

This patent application claims priority to U.S. Patent Application No. 63/382,699, filed on Nov. 7, 2022, entitled “FRAMEWORK TO ENABLE TRANSPARENT UPLINK POWER BOOSTING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for a framework to enable uplink power boosting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, in Layer 1 or Layer 2 signaling, an indication of at least one power headroom estimation pair that is based at least in part on a power boost for an uplink transmission. The method may include transmitting the uplink transmission based at least in part on the power headroom estimation pair.

Some aspects described herein relate to a method of wireless communication performed by a UE. The method may include transmitting an indication of a UE-proposed power change. The method may include transmitting an uplink transmission based at least in part on the UE-proposed power change.

Some aspects described herein relate to a method of wireless communication performed by a network node. The method may include receiving, in Layer 1 or Layer 2 signaling, an indication of at least one power headroom estimation pair that is based at least in part on a power boost for an uplink transmission. The method may include receiving the uplink transmission based at least in part on the power headroom estimation pair.

Some aspects described herein relate to a method of wireless communication performed by a network node. The method may include receiving an indication of a UE-proposed power change. The method may include transmitting an indication of a scheduled power level that is based at least in part on the UE-proposed power change.

Some aspects described herein relate to an apparatus for wireless communication at a UE. The apparatus may include a memory and one or more processors coupled to the memory. The one or more processors may be configured to cause the apparatus to transmit, in Layer 1 or Layer 2 signaling, an indication of at least one power headroom estimation pair that is based at least in part on a power boost for an uplink transmission. The one or more processors may be configured to transmit the uplink transmission based at least in part on the power headroom estimation pair.

Some aspects described herein relate to an apparatus for wireless communication at a UE. The apparatus may include a memory and one or more processors coupled to the memory. The one or more processors may be configured to cause the apparatus to transmit an indication of a UE-proposed power change. The one or more processors may be configured to transmit an uplink transmission based at least in part on the UE-proposed power change.

Some aspects described herein relate to an apparatus for wireless communication at a network node. The apparatus may include a memory and one or more processors coupled to the memory. The one or more processors may be configured to cause the apparatus to receive, in Layer 1 or Layer 2 signaling, an indication of at least one power headroom estimation pair that is based at least in part on a power boost for an uplink transmission. The one or more processors may be configured to cause the network node to receive the uplink transmission based at least in part on the power headroom estimation pair.

Some aspects described herein relate to an apparatus for wireless communication at a network node. The apparatus may include a memory and one or more processors coupled to the memory. The one or more processors may be configured to receive an indication of a UE-proposed power change. The one or more processors may be configured to transmit an indication of a scheduled power level that is based at least in part on the UE-proposed power change.

Some aspects described herein relate to a non-transitory computer-readable medium that stores a set of instructions for wireless communication by a UE. The set of instructions, when executed by one or more processors of the UE, may cause the UE to transmit, in Layer 1 or Layer 2 signaling, an indication of at least one power headroom estimation pair that is based at least in part on a power boost for an uplink transmission. The set of instructions, when executed by one or more processors of the UE, may cause the UE to transmit the uplink transmission based at least in part on the power headroom estimation pair.

Some aspects described herein relate to a non-transitory computer-readable medium that stores a set of instructions for wireless communication by a UE. The set of instructions, when executed by one or more processors of the UE, may cause the UE to transmit an indication of a UE-proposed power change. The set of instructions, when executed by one or more processors of the UE, may cause the UE to transmit an uplink transmission based at least in part on the UE-proposed power change.

Some aspects described herein relate to a non-transitory computer-readable medium that stores a set of instructions for wireless communication by a network node. The set of instructions, when executed by one or more processors of the network node, may cause the network node to receive, in Layer 1 or Layer 2 signaling, an indication of at least one power headroom estimation pair that is based at least in part on a power boost for an uplink transmission. The set of instructions, when executed by one or more processors of the network node, may cause the network node to receive the uplink transmission based at least in part on the power headroom estimation pair.

Some aspects described herein relate to a non-transitory computer-readable medium that stores a set of instructions for wireless communication by a network node. The set of instructions, when executed by one or more processors of the network node, may cause the network node to receive an indication of a UE-proposed power change. The set of instructions, when executed by one or more processors of the network node, may cause the network node to transmit an indication of an indication of a scheduled power level that is based at least in part on the UE-proposed power change.

Some aspects described herein relate to an apparatus for wireless communication. The apparatus may include means for transmitting, in Layer 1 or Layer 2 signaling, an indication of at least one power headroom estimation pair that is based at least in part on a power boost for an uplink transmission. The apparatus may include means for transmitting the uplink transmission based at least in part on the power headroom estimation pair.

Some aspects described herein relate to an apparatus for wireless communication. The apparatus may include means for transmitting an indication of a UE-proposed power change. The apparatus may include means for transmitting an uplink transmission based at least in part on the UE-proposed power change.

Some aspects described herein relate to an apparatus for wireless communication. The apparatus may include means for receiving, in Layer 1 or Layer 2 signaling, an indication of at least one power headroom estimation pair that is based at least in part on a power boost for an uplink transmission. The apparatus may include means for receiving the uplink transmission based at least in part on the power headroom estimation pair.

Some aspects described herein relate to an apparatus for wireless communication. The apparatus may include means for receiving an indication of a UE-proposed power change. The apparatus may include means for transmitting scheduled power level that is based at least in part on the UE-proposed power change.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment, of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antennas, RF-chains, power amplifiers, modulators, buffers, processor(s), interleavers, adders/summers, etc.). It is intended that innovations described herein may be practiced in a wide variety of devices, chip-level components, systems, distributed arrangements, end-user devices, etc. of varying sizes, shapes, and constitution.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of power headroom reporting, in accordance with the present disclosure.

FIG. 6 is a diagram illustrating an example of a wireless communication process between a network node and a UE, in accordance with the present disclosure.

FIG. 7 is a diagram illustrating an example of a wireless communication process between a network node and a UE, in accordance with the present disclosure.

FIG. 8 is a diagram illustrating an example medium access control (MAC) control element that may be used to report a power boost that is associated with an alternative modulation and coding scheme, in accordance with the present disclosure.

FIG. 9 is a diagram illustrating an example process performed, for example, by a UE, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram illustrating an example process performed, for example, by a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

In some aspects, a power headroom (PH) associated with a power boost for an uplink transmission may be based at least in part on a modulation order and/or a user equipment (UE) configuration. To illustrate, a first UE may report a first power headroom associated with a waveform that is based at least in part on a scheduled modulation and coding scheme (MCS), and a second UE may report a second, different power headroom for the same waveform and/or scheduled MCS based at least in part on a respective implementation of each UE. As one example, the first UE may implement and/or optimize power boosting for the scheduled MCS, and the second UE may implement and/or optimize power boosting for a second, different (unscheduled) MCS.

A network node scheduling the first UE and the second UE may be unaware of UE capabilities associated with power boosting. To illustrate, power headroom reporting may be relevant to a scheduled MCS, and not to an unscheduled MCS that a UE optimizes for power boosting. Accordingly, without information that indicates UE-specific power boosting capabilities, a network node may schedule an MCS that reduces a UE's ability to transmit at a higher power level, which may result in reduced signal quality, increased recovery errors, increased data transfer delays, and/or reduced data throughput.

Various aspects relate generally to a framework to enable uplink power boosting. Some aspects more specifically relate to a UE indicating a power boosting capability that is associated with an unscheduled modulation order. A UE may transmit an indication of a power headroom estimation pair that is based at least in part on a power boost for an uplink transmission. To illustrate, the power headroom estimation pair may indicate an unscheduled modulation order and/or a power headroom estimation (e.g., a power headroom report) that is associated with the unscheduled modulation order. In some aspects, the UE may transmit an uplink transmission that is based at least in part on the power headroom estimation pair.

Alternatively, or additionally, a UE may transmit an indication of a UE-proposed power change, such as a UE-proposed power change that indicates a power difference and/or a power boost that the UE is capable of providing for an uplink transmission. In some aspects, the UE-proposed power change may be based at least in part on a power class associated with the UE. In some aspects, the UE may transmit an uplink transmission based at least in part on the UE-proposed power change. In some aspects, a network node may adjust a scheduled power level based at least in part on the UE-proposed power change and/or the power headroom estimation pair.

By indicating a power headroom estimation pair and/or a UE-proposed power change, a UE may provide a network node with information that enables the network node to schedule the UE with a modulation order that the UE may optimize for a power boost (e.g., may optimize to increase a power level of the power boost). Optimizing the power boost for the uplink transmission may enable the UE to transmit an uplink communication at a higher power level (e.g., relative to an uplink transmission that is based at least in part on a different modulation order) that results in an improved signal quality, reduced recovery errors, reduced data transfer delays, and/or increased data throughput.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

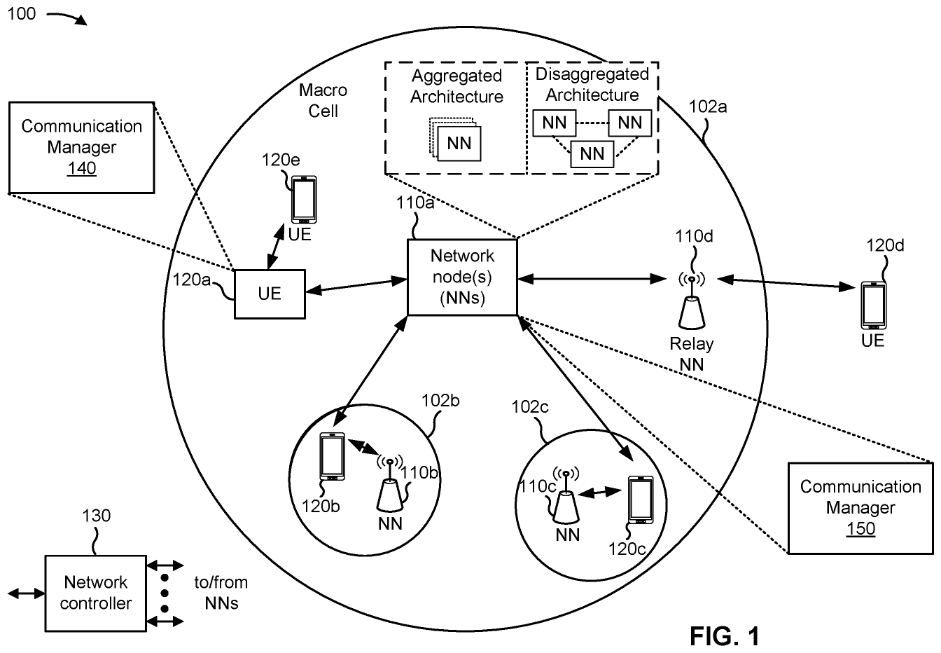

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may transmit, in Layer 1 or Layer 2 signaling, an indication of at least one power headroom estimation pair that is based at least in part on a power boost for an uplink transmission; and transmit the uplink transmission based at least in part on the power headroom estimation pair.

In some aspects, the communication manager 140 may transmit an indication of a UE-proposed power change; and transmit an uplink transmission based at least in part on the UE-proposed power change. Additionally, or alternatively, the communication manager 140 may perform one or more other operations described herein.

In some aspects, a network node (e.g., the network node 110) may include a communication manager 150. As described in more detail elsewhere herein, the communication manager 150 may receive an indication of a UE-proposed power change; and transmit an indication of a scheduled power level that is based at least in part on the UE-proposed power change.

In some aspects, the communication manager 150 may receive, in Layer 1 or Layer 2 signaling, an indication of at least one power headroom estimation pair that is based at least in part on a power boost for an uplink transmission; and receive the uplink transmission based at least in part on the power headroom estimation pair. Additionally, or alternatively, the communication manager 150 may perform one or more other operations described herein.

As indicated above, FIG. 1 is provided as an example. Other examples may differ from what is described with regard to FIG. 1.

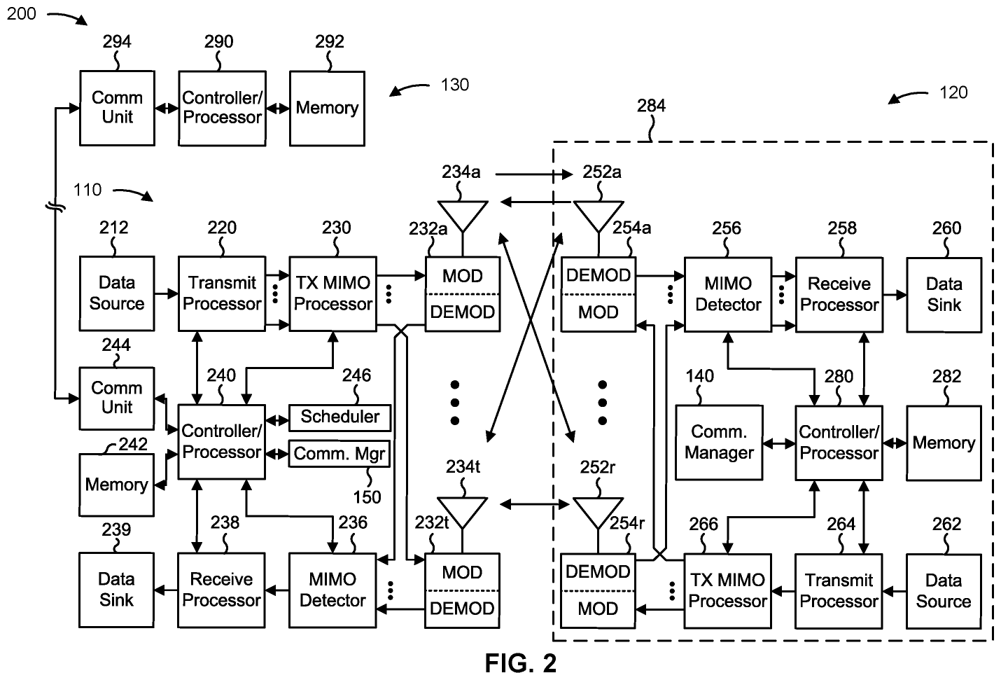

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

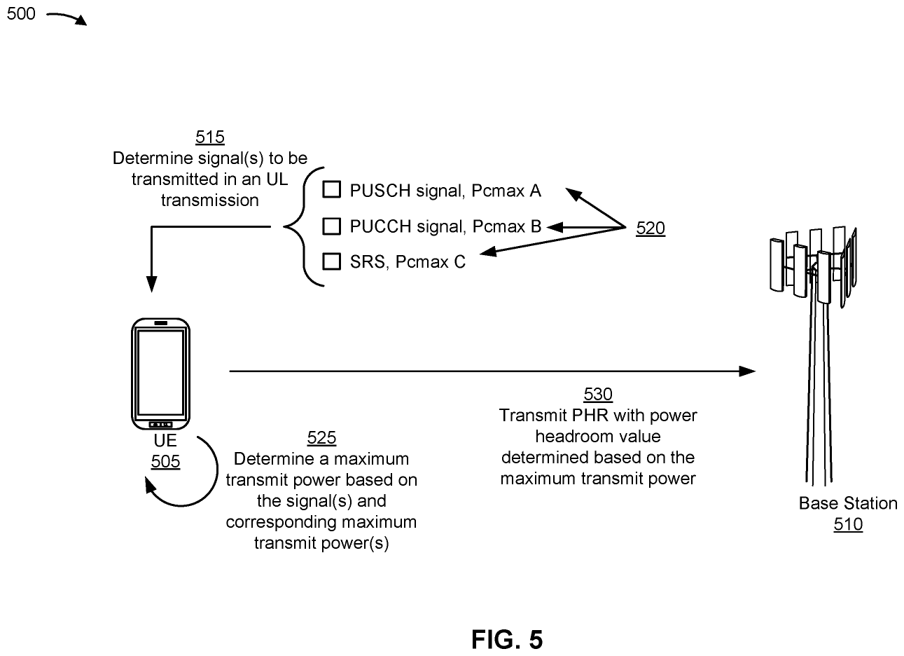

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for a cyclic prefix (CP) OFDM (CP-OFDM) waveform or discrete Fourier transform spread OFDM (DFT-s-OFDM) waveform), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

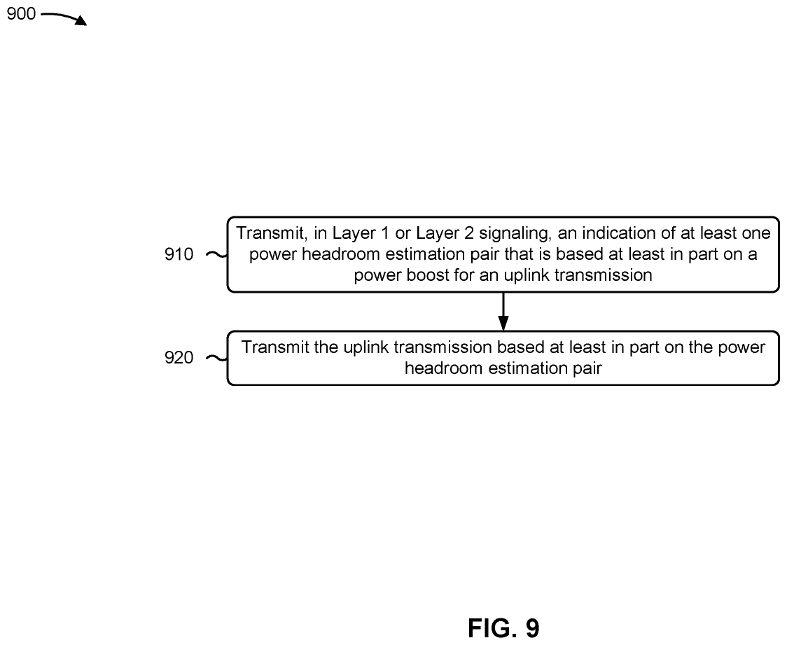

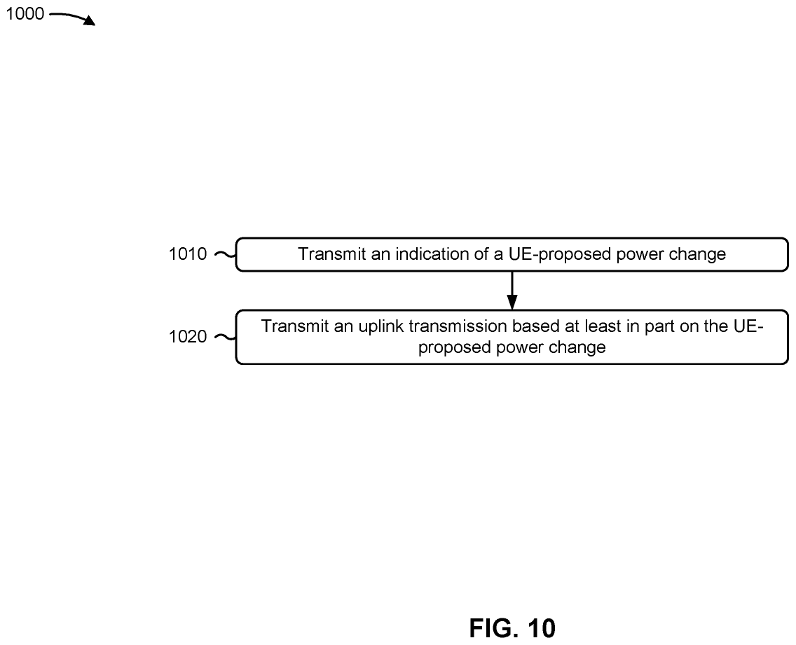

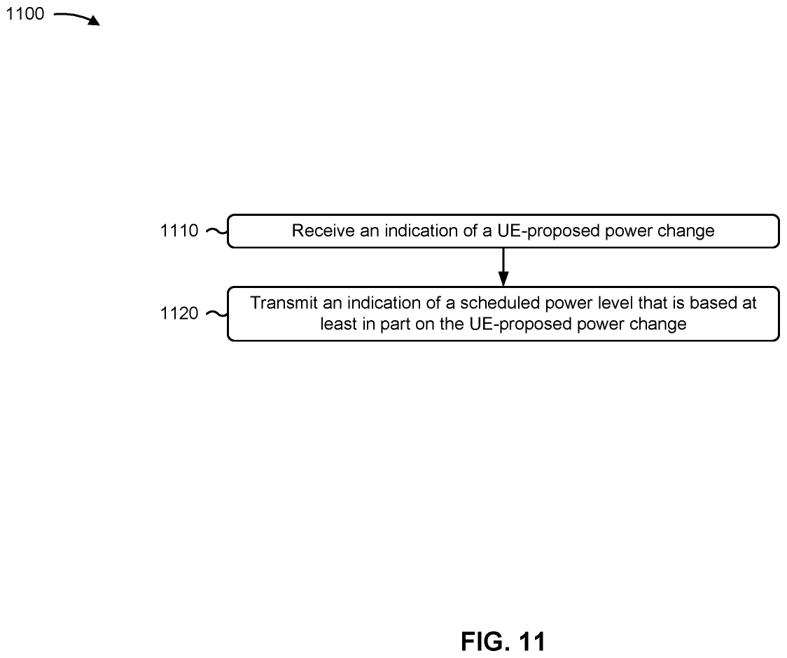

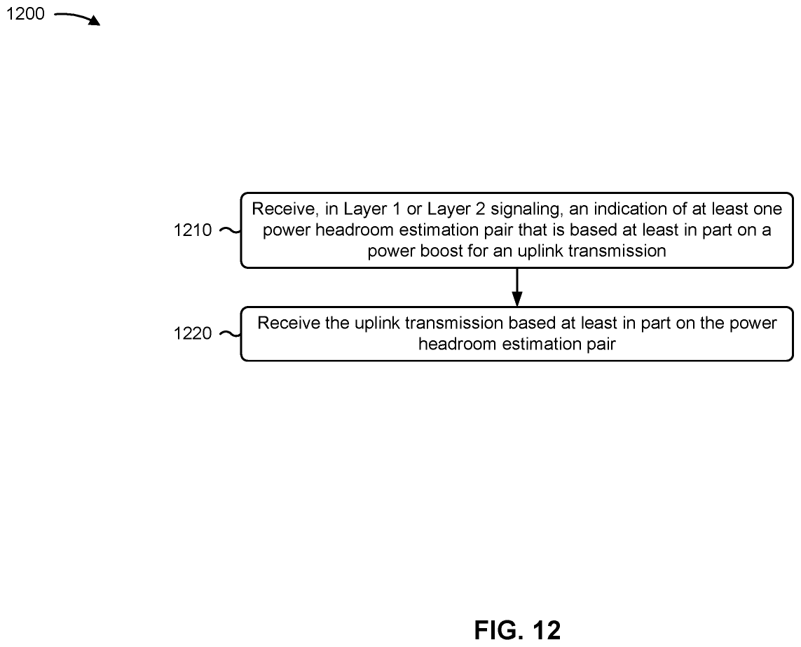

The controller/processor 240 of the network node 110, the controller/processor 280 of the UE 120, and/or any other component(s) of FIG. 2 may perform one or more techniques associated with a framework to enable uplink power boosting, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting, in Layer 1 or Layer 2 signaling, an indication of at least one power headroom estimation pair that is based at least in part on a power boost for an uplink transmission; and/or means for transmitting the uplink transmission based at least in part on the power headroom estimation pair.

In some aspects, the UE includes means for transmitting an indication of a UE-proposed power change; and/or means for transmitting an uplink transmission based at least in part on the UE-proposed power change.

The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving an indication of a UE-proposed power change; and/or means for transmitting an indication of a scheduled power level that is based at least in part on the UE-proposed power change.

In some aspects, the network node includes means for receiving, in Layer 1 or Layer 2 signaling, an indication of at least one power headroom estimation pair that is based at least in part on a power boost for an uplink transmission; and/or means for receiving the uplink transmission based at least in part on the power headroom estimation pair.

The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

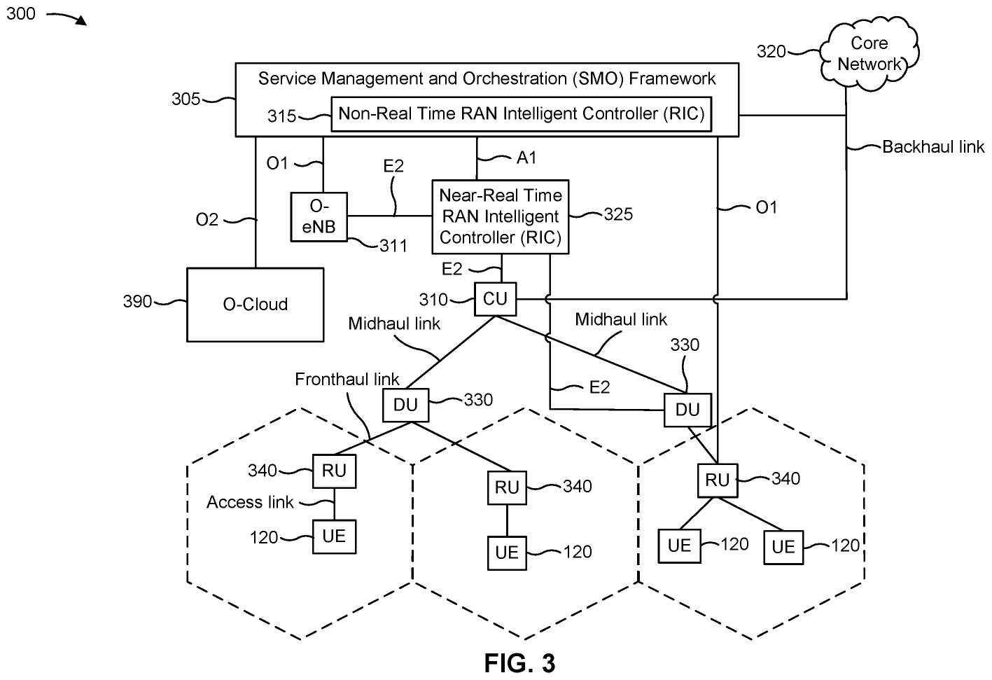

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

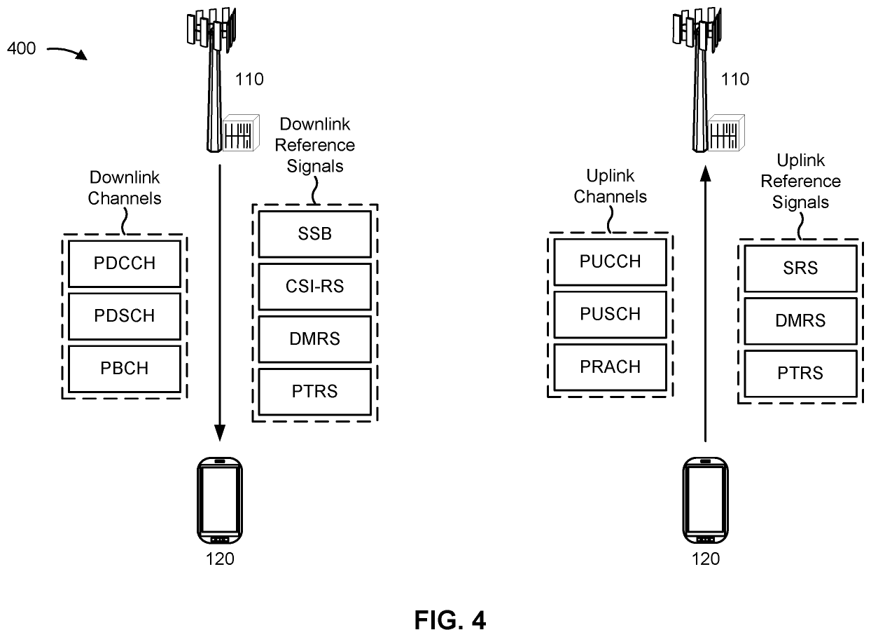

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a PRACH used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a precoding matrix indicator (PMI), a CSI-RS resource indicator (CRI), a layer indicator (LI), a rank indicator (RI), or an RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

FIG. 5 is a diagram illustrating an example 500 of power headroom reporting, in accordance with the present disclosure.

As shown in FIG. 5, a UE 505 may communicate with a network node 510 to perform power headroom reporting. In some aspects, the UE 505 may correspond to one or more UEs described elsewhere herein, such as UE 120 of FIG. 1. Alternatively, or additionally, the network node 510 may correspond to one or more base stations described elsewhere herein, such as network node 110 of FIG. 1.

As shown by reference number 515, the UE 505 may determine one or more signals, of a plurality of signals, to be transmitted in an uplink transmission. The one or more signals may include, for example, an uplink control channel signal (e.g., a PUCCH signal and/or a shortened PUCCH (sPUCCH) signal), an uplink data channel signal (e.g., a PUSCH signal, a shortened PUSCH (sPUSCH) signal, an ultra-reliable low latency communication (URLLC) PUCCH, and/or an enhanced mobile broadband (eMBB) PUCCH), an SRS, and/or another type of reference signal. In some aspects, the one or more signals include multiple signals (e.g., at least two signals, at least three signals, etc.) to be frequency division multiplexed in the uplink transmission. For example, an uplink control channel signal and an SRS may be frequency division multiplexed; an uplink data channel signal and an SRS may be frequency division multiplexed; an uplink control channel signal and an uplink data channel signal may be frequency division multiplexed; an uplink control channel signal, an uplink data channel signal, and an SRS may be frequency division multiplexed; and/or the like.

As shown by reference number 520, different signals of the plurality of signals may correspond to different maximum transmit powers, such as a configured maximum output power (P_{cmax}) value and/or a maximum allowed output power (Pₑₘₐₓ) value. For example, a PUSCH signal may correspond to a first maximum transmit power, shown as P_{cmax} A, a PUCCH signal may correspond to a second maximum transmit power, shown as P_{cmax} B, an SRS may correspond to a third maximum transmit power, shown as P_{cmax} C, and/or the like. These signals and corresponding maximum transmit powers are shown as examples, and other examples are possible.

As shown by reference number 525, the UE 505 may determine a maximum transmit power, to be used to determine a power headroom value, based at least in part on the one or more signals and the corresponding one or more maximum transmit powers. When different signals correspond to different maximum transmit powers (e.g., P_{cmax} or Pₑₘₐₓ values), then the UE 505 may determine a particular maximum transmit power to be used to calculate the power headroom value. For example, the power headroom value may be calculated as a difference between a maximum transmit power (e.g., P_{cmax} or Pₑₘₐₓ) and a transmit power that would have been used without power constraints (e.g., which may be an unconstrained transmit power for a single signal or a sum of unconstrained transmit powers for multiple signals, such as higher priority signals).

In the case where one signal is included in the uplink transmission, then the UE 505 may use the maximum transmit power corresponding to that one signal. However, if multiple signals are frequency division multiplexed in the uplink transmission, then the UE 505 may determine a maximum transmit power based at least in part on the multiple signals. In some aspects, the UE 505 may select a maximum transmit power corresponding to the highest priority signal to be transmitted. For example, if the plurality of signals includes a signal on the uplink control channel (e.g., the PUCCH), then the UE 505 may select the maximum transmit power that corresponds to the uplink control channel. In some aspects, the UE 505 may always use a particular maximum transmit power, associated with a particular signal (e.g., an uplink control channel signal) regardless of whether that signal is being transmitted. In this way, the UE 505 may conserve processing resources by simplifying selection of the maximum transmit power value to be used to determine the power headroom value.

Additionally, or alternatively, the UE 505 may determine the maximum transmit power based at least in part on an indication, associated with the plurality of signals, indicated in an RRC message. For example, an RRC message (e.g., from the network node 510) may indicate which maximum transmit power to use for different combinations of multiple signals. Additionally, or alternatively, the UE 505 may determine the maximum transmit power based at least in part on a maximum transmit power of a signal that is included in the uplink transmission. Additionally, or alternatively, the UE 505 may determine the maximum transmit power based at least in part on multiple maximum transmit powers corresponding to multiple signals included in the uplink transmission. For example, the UE 505 may average the multiple maximum transmit powers, may select a maximum of the maximum transmit powers, may select a minimum of the maximum transmit powers, and/or the like.

In some aspects, the uplink transmission may be transmitted on a particular beam (e.g., a particular antenna beam), and different beams may be associated with different maximum transmit powers (e.g., P_{cmax} or Pₑₘₐₓ values). In this case, the UE 505 may determine the maximum transmit power based at least in part on a beam via which the uplink transmission is to be transmitted. Additionally, or alternatively, the UE 505 may determine the maximum transmit power based at least in part on whether the plurality of signals are transmitted on a same beam or different beams. For example, if the plurality of signals are transmitted on different beams, then the UE 505 may use a maximum transmit power corresponding to a particular signal, such as an uplink control signal. In some aspects, the UE 505 may determine the maximum transmit power based at least in part on whether the signals to be included in the uplink transmission are frequency division multiplexed across an entire transmission time of the uplink transmission or a partial transmission time of the uplink transmission. In this way, the maximum transmit power to be used to calculate a power headroom value may be determined in accordance with transmission characteristics, thereby improving performance.

As shown by reference number 530, the UE 505 may transmit a power headroom report (PHR) that indicates a power headroom value determined based at least in part on the maximum transmit power. In some aspects, the UE 505 may transmit the PHR on an uplink control channel. Additionally, or alternatively, the UE 505 may transmit the PHR as part of uplink control information that is included on an uplink data channel (e.g., with or without inclusion of uplink data on the uplink transmission).

In some aspects, the UE 505 may determine to transmit the PHR on the uplink control channel based at least in part on a determination that the uplink control channel is a particular format. Additionally, or alternatively, the UE 505 may determine to transmit the PHR on the uplink control channel based at least in part on a determination that a payload size of the uplink transmission satisfies a condition (e.g., is less than or equal to a threshold). In some aspects, the UE 505 may determine to transmit the PHR on the uplink control channel based at least in part on a determination that a resource block allocation for the uplink transmission satisfies a condition. Additionally, or alternatively, the UE 505 may determine to transmit the PHR on the uplink control channel based at least in part on a determination that uplink control information, being carried on the uplink control channel, is of a particular type. In this way, the UE 505 may transmit the PHR on the uplink control channel when conditions are favorable for such a transmission (e.g., uplink control channel traffic is low, there are sufficient resource blocks (RB s) to carry the PHR, and/or the like).

In some aspects, a PHR may be triggered when the UE 505 does not have a signal to transmit on the uplink transmission and/or has only a subset of the plurality of signals for transmission. In this case, the UE 505 may use one or more nominal signal configurations, corresponding to one or more signals, to determine the power headroom value. In some aspects, a plurality of different nominal signal configurations may correspond to the plurality of signals. For example, a nominal signal configuration for an uplink control channel signal may include a particular format (e.g., a PUCCH format) and/or the like. Additionally, or alternatively, a nominal signal configuration for an uplink data channel signal may include any combination of a particular MCS, a particular code rate, a particular bandwidth for the SRS, a particular number and/or combination of SRS tones, and/or a particular tone spacing, and/or the like. In some aspects, different combinations of signals may correspond to different nominal signal configurations. A nominal signal configuration may be signaled to the UE 505 in a system information message, an RRC message, in a MAC control element (CE), in downlink control information, and/or the like. In this way, the UE 505 may report a power headroom value when the UE 505 does not have information to transmit.

Additionally, or alternatively, when the UE 505 does not have a signal to transmit on the uplink transmission, the UE 505 may use a reference beam (e.g., a default beam) to determine the power headroom value. In some aspects, different reference beams may be used for different signals, and the reference beam may be determined based at least in part on a signal associated with the PHR. In some aspects, the reference beam may be determined as a function of time (e.g., using a slot index). In this way, the UE 505 may transmit PHRs corresponding to all of the different configured beams. Additionally, or alternatively, the reference beam (e.g., a configuration for the reference beam) may be signaled to the UE 505 in an RRC message, in a MAC control element, in downlink control information, and/or the like. In this way, the UE 505 may report a power headroom value when the UE 505 does not have information to transmit.

Additionally, or alternatively, the PHR may be associated with multiple repetitions of the uplink transmission. For example, the uplink transmission may be repeated (e.g., in different slots) to increase reliability. In some cases, the power headroom value may change across different repetitions (e.g., when the UE 505 receives a transmit power command from the network node 510 between repetitions). However, a MAC control element may be maintained (e.g., kept the same) across different repetitions. In this case, if the reported power headroom value associated with the multiple repetitions corresponds only to the first repetition, this may lead to an inaccurate representation of the power headroom across multiple repetitions when there is a difference in uplink transmissions that include the multiple repetitions.

Thus, for more accurate power headroom reporting, the power headroom value may be determined based at least in part on a number of repetitions associated with the uplink transmission. Additionally, or alternatively, the power headroom value may be based at least in part on one or more signals included in the multiple repetitions. For example, if there are many repetitions (e.g., more than a threshold), but only one of the repetitions (e.g., the first) or a few repetitions (e.g., less than a threshold) are frequency division multiplexed with a particular signal (e.g., an SRS), then the UE 505 may exclude values associated with the particular signal when determining the power headroom value. Additionally, or alternatively, if a majority or some threshold number of repetitions include at least two signals (e.g., a PUCCH signal and a PUSCH signal), then the UE 505 may include value associated with those signals when determining the power headroom value. In this way, the UE 505 may more accurately report a power headroom value associated with the multiple repetitions.

In some aspects, the UE 505 may determine the power headroom value based at least in part on a beam-specific power limitation associated with the UE 505. For example, in addition to beam-specific power limitations indicated by the network node 510 (e.g., a beam-specific Pₑₘₐₓ value, beam-specific maximum power reduction (MPR) value, and/or the like), the UE 505 may have constraints on the maximum transmit power in one or more beam directions. For example, one such constraint includes a maximum permissible exposure (MPE) constraint to prevent too much radiation exposure to the human body. In some aspects, the UE 505 may signal such UE-side beam-specific power limitation to the network node 510, and the network node 510 may reconfigure one or more beam-specific power parameters (e.g., Pₑₘₐₓ and/or the like) for the affected beam(s). The network node 510 may indicate the reconfigured beam-specific power parameter(s) to the UE 505, and the UE 505 may use these parameter(s) to determine the power headroom value for the affected beams. Additionally, or alternatively, the UE 505 may autonomously reduce the maximum transmit power (P_{cmax}) based at least in part on the UE-side beam-specific power limitation, thereby reporting a lower power headroom value. In this case, the maximum transmit power (P_{cmax}) for a beam may depend on a beam-specific Pₑₘₐₓ value, a beam-specific MPR value, and/or a beam-specific offset due to the UE-side beam-specific power limitation (e.g., an MPE constraint and/or the like).

In some aspects, the UE 505 may report (e.g., using a PHR) a power headroom value, the reduced maximum transmit power, the maximum transmit power before reduction, and/or the beam-specific offset to the network node 510. Additionally, or alternatively, the UE 505 may report (e.g., using a PHR), a plurality of reports (e.g., a plurality of PHRs) corresponding to a plurality of beams (e.g., one or more beams other than the beam used in a slot that includes a report). In some aspects, the plurality of beams may be identified in the plurality of reports using a plurality of beam identifiers. Additionally, or alternatively, the plurality of beams may be identified implicitly, such as by an order of the reports that corresponds to the beams. For example, a first report may correspond to a first beam (e.g., a control beam), a second report may correspond to a second beam (e.g., a data beam), and/or the like. Such ordering may be indicated in, for example, an RRC message, a MAC control element, DCI, and/or the like.

In some aspects, transmission of a PHR may be triggered based at least in part on a change in a UE-side beam-specific power limitation satisfying a threshold. In this way, the UE 505 may notify the network node 510 regarding power constraints on the UE 505, and may modify scheduling and/or beam management accordingly. The threshold itself may be beam-specific and may be configured by RRC, MAC CE or DCI, for example, when the beam is configured.

The above methods regarding reporting one or more beam-specific PHRs possibly based on beam-specific pathloss triggers can also be extended to waveform-specific PHR reporting, or to any combination of waveform-specific, channel-specific, and/or beam-specific PHR reporting. Some or all of the parameters governing the PHR calculation, including a network configured Pₑₘₐₓ, the MPR, a UE determined P_{cmax} which is related to P_{cmax}, and MPR, and/or transmit power for transmitted signals, could be dependent on the waveform to be used for the transmitted signal, for example, whether the waveform is CP-OFDM or DFT-s-OFDM.

When reporting PHR for slots in which there is no transmitted signal, a nominal transmission waveform (for example, DFT-s-OFDM) could be used. Additionally, or alternatively, multiple PHRs could be reported, one for each possible waveform type. The waveform type for each PHR could be explicitly indicated as part of the PHR or implicitly determined by the ordering of the PHRs. Further, the PHR reporting itself could be triggered based at least in part on the waveform type. For example, a new PUSCH packet may include PHR under certain combinations of the waveform to be used for this packet and the waveform that was used for the previous uplink transmission, or for the previous uplink PUSCH transmission. For example, PHR may be reported aperiodically whenever the PUSCH waveform changes, or only when it changes from DFT-s-OFDM to CP-OFDM. If the waveform changes during a hybrid automatic repeat request (HARM) re-transmission of PUSCH, this may constitute a trigger to transmit PHR aperiodically on the following new PUSCH packet, or with the next PUCCH transmission, or with whichever of these comes earlier.

Additionally, or alternatively, PHR transmission may be triggered aperiodically by padding conditions. For example, if the UE 505 received a large PUSCH grant but did not have sufficient data to send on the PUSCH grant, the UE 505 may fill up the packet with PHR reports for multiple slots, beams, waveforms, PHR-report types, channel types, or any combination thereof. Additionally, or alternatively, PHR transmission may be dynamically triggered by the network node 510 using an aperiodic indication. For example, the trigger could be in DCI scheduling for an uplink data channel (e.g., PUSCH), in DCI scheduling a downlink data channel (e.g., PDSCH) and a corresponding ACK on an uplink control channel (e.g., PUCCH), in the MAC CE of the scheduled downlink data channel (e.g., PDSCH), and/or the like.

In some aspects, transmission of the PHR may be periodic. Additionally, or alternatively, transmission of the PHR may be triggered aperiodically. For example, transmission of the power headroom report may be triggered based at least in part on a change in path loss, detected by the UE 505, satisfying a threshold. In some aspects, the change in path loss may be beam-specific. In this case, the threshold may be beam-specific. Additionally, or alternatively, transmission of the PHR may be triggered for a specific beam. Additionally, or alternatively, a nominal signal configuration and/or a reference beam to be used to determine the power headroom value may be determined based at least in part on the beam that activated the path loss-based trigger. In this way, PHRs may be triggered for specific beams based on network conditions, thereby improving performance when network conditions are poor.

As described above, a UE (e.g., a UE 120) may communicate with a network node (e.g., a network node 110) using one or more different types of waveforms. For example, the UE may communicate based at least in part on using a DFT-s-OFDM waveform or a CP-OFDM waveform, and each waveform may be associated with different characteristics. For example, a CP-OFDM waveform may support MIMO communications, which may not be supported when using a DFT-s-OFDM waveform. As another example, a DFT-s-OFDM waveform may support a higher transmission power than a CP-OFDM waveform. This may occur because the CP-OFDM waveform may be associated with a larger amount of power backoff at an input to a power amplifier than is used for the DFT-s-OFDM waveform.

In some aspects, a network node may receive a PHR that is based at least in part on a waveform. For example, the network node may receive, from a UE, information regarding a set of channel characteristics observed using a particular waveform. The PHR may be configured on a per cell group basis with one or more triggers identifying a condition that, when satisfied, is to trigger transmission of the PHR, such as a periodicity, a timer, or a power change threshold. The power headroom report may include a set of fields for identifying a power headroom (e.g., a first 6 bits), a maximum power P_{cmax} (e.g., a second 6 bits), an MPE indicator (e.g., a bit indicator of whether MPE is being reported), or an MPE value (e.g., a 2 bit indicator), among other examples. Additional details regarding power headroom reporting and P_{cmax} reporting are described in 3GPP Technical Specification (TS) 38.331 version 17.2.0, in 3GPP TS 38.321 version 17.2.0, 3GPP TS 38.133 version 17.7.0, and 3GPP TS 38.101 version 17.7.0.

In some aspects, a power headroom associated with a power boost for an uplink transmission may be based at least in part on a modulation scheme and/or a UE configuration. To illustrate, a first UE may report a first power headroom associated with a waveform that is based at least in part on a scheduled MCS, and a second UE may report a second, different power headroom for the waveform and/or scheduled MCS. The first UE and the second UE may report different power headrooms for the same scheduled MCS based at least in part on a respective implementation of each UE. As one example, the first UE may implement and/or optimize power boosting for the scheduled MCS (e.g., an associated modulation order and/or associated modulation type), and the second UE may implement and/or optimize power boosting for a second, different (unscheduled) MCS (e.g., a different modulation order and/or a different modulation type).

A network node scheduling the first UE and the second UE may be unaware of UE capabilities associated with power boosting. That is, the network node may be unaware that the first UE is implemented to optimize power boosting at the (scheduled) MCS and/or that the second UE is implemented to optimize power boosting at a different (unscheduled) MCS. In some aspects, current power headroom reporting, such as that described with regard to 3GPP TS 38.331 version 17.2.0, 3GPP TS 38.321 version 17.2.0, 3GPP TS 38.133 version 17.7.0, and/or 3GPP TS 38.101 version 17.7.0 may be relevant to a scheduled MCS, and not a UE-specific MCS that optimizes power boosting. Accordingly, without information that indicates UE-specific power boosting optimization capabilities, a network node may schedule an MCS that reduces a UE's ability to transmit at a higher power level and may result in reduced signal quality, increased recovery errors, increased data transfer delays, and/or reduced data throughput.

Some techniques and apparatuses described herein provide a framework to enable uplink power boosting. A UE may transmit, in Layer 1 or Layer 2 signaling, an indication of at least one power headroom estimation pair that is based at least in part on a power boost for an uplink transmission. As one example, the power headroom estimation pair may be based at least in part on an unscheduled modulation order and/or a power headroom report associated with the unscheduled modulation order. In some aspects, the unscheduled modulation order may be based at least in part on an unscheduled MCS. Based at least in part on indicating the at least one power headroom estimation pair, the UE may transmit the uplink transmission based at least in part on the power headroom estimation pair. To illustrate, the UE may transmit the uplink transmission (e.g., an uplink transmission that indicates the at least one power headroom estimation pair) based at least in part on the unscheduled modulation order. Alternatively or additionally, a network node may receive the uplink transmission and recover information from the uplink transmission based at least in part on the at least one power headroom estimation pair (e.g., the unscheduled modulation order).

In some aspects, a UE transmits an indication of a UE-proposed power change. To illustrate, the UE may transmit a value that indicates a power difference and/or a power boost that the UE is capable of providing for an uplink transmission. In some aspects, the UE-proposed power change may be based at least in part on a power class associated with the UE. To illustrate, the power class may be associated with a nominal transmission power, and the UE-proposed power change may indicate a change to the nominal transmission power. For instance, as described above, the UE-proposed power change may be based at least in part on a UE-specific implementation for power boosting (e.g., an optimal configuration). In some aspects, the UE may transmit an uplink transmission based at least in part on the UE-proposed power change, such as by transmitting a PUSCH, a PUCCH and/or SRS using a power level that is based at least in part on the UE-proposed power change. As one example, the UE may transmit the uplink transmission using an indication of a scheduled power level (e.g., by a network node) that is based at least in part on the UE-proposed power change. That is, the network node may adjust an indication of a scheduled power level based at least in part on the UE-proposed power change.

By indicating a power headroom estimation pair and/or a UE-proposed power change, a UE may provide a network node with information that enables the network node to recover an uplink transmission that is based at least in part on a UE-specific power boost optimization (e.g., an uplink transmission that uses an unscheduled modulation order) and/or enables the network node to schedule the UE with a UE-specific modulation order that optimizes a power boost for an uplink transmission by the UE. Optimizing the power boost for the uplink transmission may enable the UE to transmit an uplink communication at a higher power level (e.g., relative to an uplink transmission that is based at least in part on a different modulation order) that results in an improved signal quality, reduced recovery errors, reduced data transfer delays, and/or increased data throughput.

As indicated above, FIG. 5 is provided as an example. Other examples may differ from what is described with regard to FIG. 5.

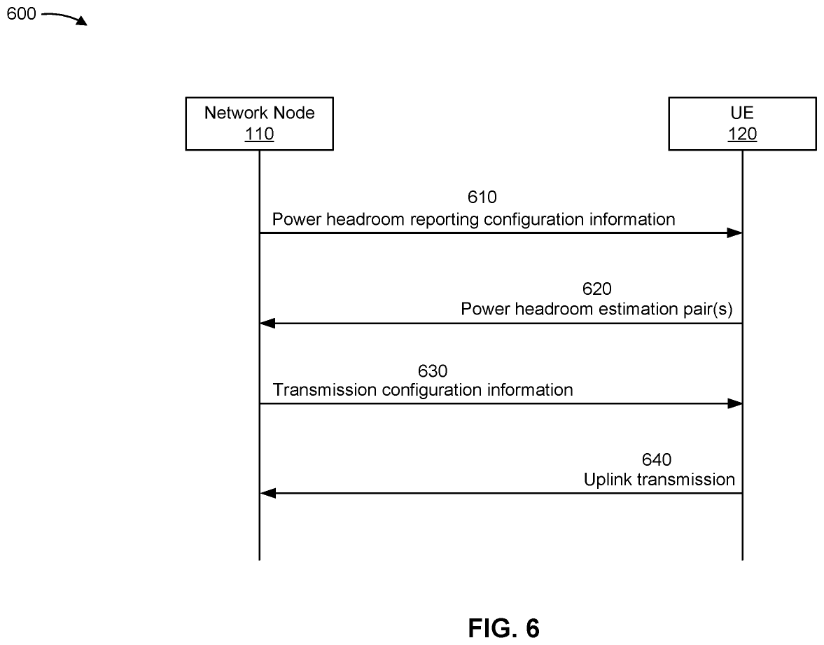

FIG. 6 is a diagram illustrating an example 600 of a wireless communication process between a network node (e.g., the network node 110) and a UE (e.g., the UE 120), in accordance with the present disclosure.

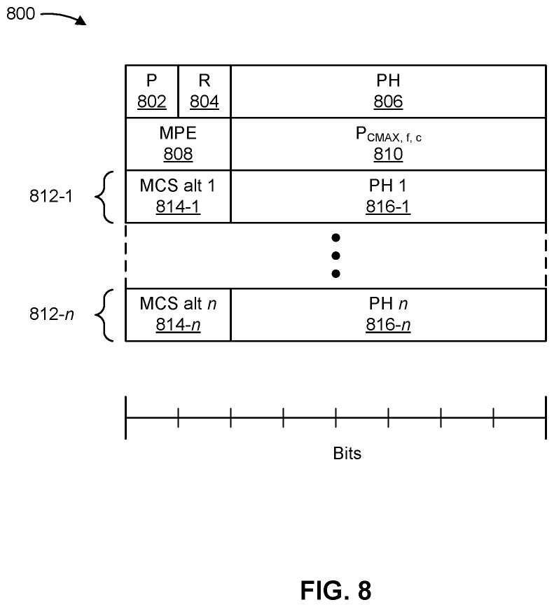

As shown by reference number 610, a network node 110 may transmit, and a UE 120 may receive, an indication of power headroom reporting configuration information. In some aspects, the power headroom reporting configuration information may specify a reporting configuration to use for reporting power headroom information. To illustrate, the power headroom reporting configuration information may indicate to report a power headroom estimation pair based at least in part on using a power headroom estimation pair MAC CE format. A MAC CE format may partition a MAC CE into different bitfields that may be of varying length, such as an example power headroom estimation pair MAC CE format as described with regard to FIG. 8.

In some aspects, a power headroom estimation pair MAC CE format may include at least a power headroom reporting field (e.g., a 6-bit field) for indicating a first power headroom that is associated with a scheduled MCS, and one or more power headroom estimation pair fields for indicating a second power headroom estimation report that is associated with an unscheduled modulation order (e.g., a number of bits per modulation symbol). A power headroom estimation pair field may include multiple bit fields, and each bit field may explicitly indicate a value. As one example, each power headroom estimation pair field may be an 8-bit field that is partitioned into a power headroom estimation field (e.g., a 6-bit field) for specifying a power headroom estimation and/or an alternate modulation order field (e.g., a 2-bit field) for specifying a modulation order that is associated with the power headroom estimation. As another example, the power headroom estimation pair MAC CE format may partition an existing field, such as the power headroom reporting field for indicating a power headroom that is associated with a scheduled MCS, into a first bit field (e.g., a 4-bit field) for a power headroom estimation field for indicating a power boost associated with an unscheduled modulation order, and a second bit field (e.g., a 2-bit field) for specifying the associated modulation order that is in the power headroom estimation pair. Accordingly, a power headroom estimation pair field may explicitly indicate a power headroom estimation and explicitly indicate an unscheduled modulation order.

In another example, the power headroom estimation pair field may explicitly indicate the power headroom estimation and implicitly indicate the unscheduled modulation order. To illustrate, the power headroom estimation pair field may implicitly indicate the unscheduled modulation order based at least in part on a location of the power headroom estimation pair field in a transmission and/or based at least in part on the UE 120 using the unscheduled modulation order for an uplink transmission. For instance, a MAC CE may include a list of multiple power headroom estimation pair fields as described with regard to FIG. 8, and an order of the list may implicitly indicate an unscheduled modulation order. To illustrate, a power headroom estimation pair in a first position and/or location in the list may implicitly indicate an unscheduled modulation order of X, and a power headroom estimation pair in a second position and/or second location in the list may implicitly indicate an unscheduled modulation order of Y, where X and Y are integers. Alternatively, or additionally, and order of the list may implicitly indicate an MCS complexity (e.g., X is an order of “1” and Y is an order of “2”), such as by listing lower ordered and/or less complex MCS first (or vice versa). Some examples of modulation orders that may be specified by the modulation order field may include an MCS (e.g., via an MCS index), a UE-selected modulation order, a network-indicated modulation order, a static modulation order stored at the UE, and/or a modulation order defined by a communication standard. Accordingly, the power headroom estimation pair MAC CE format may include adding a list of power headroom estimation pairs to a MAC CE (e.g., by appending to an end of a MAC CE) and/or by partitioning and reusing an existing field.

The network node 110 may transmit, as at least part of the power headroom reporting configuration information, a grant for one or more air interface resources to use for transmitting power headroom estimation information (e.g., a power headroom estimation that is associated with an unscheduled modulation order and/or an unscheduled MCS). To illustrate, the network node 110 may transmit a PUSCH grant that is scheduled for the power headroom estimation information.

In some aspects, the network node 110 may transmit, as at least part of the power headroom reporting configuration information, a table that may be used for mapping information and/or interpreting one or more bit fields (e.g., a bit field in a power headroom estimation pair MAC CE format). To illustrate, the network node 110 may transmit and/or configure one or more tables via RRC signaling, such as by signaling a respective value for each entry of a table. Some non-limiting examples may include an RRC configured modulation order table that specifies different modulation orders, an RRC configured MCS table that specifies different MCSs, and/or an RRC configured power headroom estimation table that specifies different power headroom estimation values. The UE 120 may select a value from an entry in the table, and set the power headroom estimation field and/or the modulation order field to an index that maps to the entry. Accordingly, a bit field that is based at least in part on a mapping to a table may reduce a number of bits included in the power headroom estimation pair MAC CE format and reduce a number of air interface resources used to transmit a corresponding MAC CE.

As shown by reference number 620, the UE 120 may transmit, and the network node 110 may receive, an indication of one or more power headroom estimation pairs. For example, the UE 120 may transmit a power headroom estimation pair in Layer 1 signaling, such as in UCI. As another example, the UE 120 may transmit a power headroom estimation pair in Layer 2 signaling, such as in a MAC CE as described with regard to FIG. 8. In some aspects, the UE 120 may transmit the power headroom estimation pair in RRC signaling. As described above, a power headroom estimation pair may indicate and/or include an unscheduled modulation order (e.g., associated with an unscheduled MCS) and a power headroom estimation associated with the unscheduled modulation order. Accordingly, the power headroom estimation pair may indicate a power boost supported by the UE 120 for an uplink transmission.

To illustrate, and as described above, the UE 120 may implement and/or optimize power boosting for an unscheduled modulation order (e.g., an unscheduled MCS) such that an uplink transmission that is based at least in part on the optimized power boosting may provide more uplink power relative to a second uplink transmission that is based at least in part on the scheduled modulation order and/or the scheduled MCS. Accordingly, the UE 120 may indicate the unscheduled modulation order and a power headroom estimation (e.g., a power boost) that is associated with the unscheduled modulation in the power headroom estimation pair. That is, the UE may indicate an alternate modulation order (e.g., an alternate MCS) to assign to and/or schedule to the UE 120. In some aspects, a power headroom estimation that is associated with an unscheduled modulation order may be based at least in part on an air interface resource (e.g., a frequency band, a frequency sub-band, and/or a carrier frequency) assigned to the UE. For instance, the UE may calculate the power headroom estimation based at least in part on the air interface resource. The power headroom estimation may indicate an absolute power or a delta power. To illustrate, the UE 120 may indicate, as the power headroom estimation indicated in the power headroom estimation pair, an absolute power headroom estimation that is associated with a maximum absolute power level. Alternatively, or additionally, the UE 120 may indicate a delta power headroom estimation, such as a power difference between a nominal power associated with a power class associated with the UE 120 and a power boost.

In some aspects, the UE 120 may transmit multiple power headroom estimation pairs in a transmission (e.g., a Layer 1 transmission, a Layer 2 transmission, and/or an RRC transmission) and indicate a number of power headroom estimation pairs that are included in the transmission. For instance, the UE 120 may include multiple power headroom estimation pairs in a MAC CE and/or an RRC message, such as by appending the power headroom estimation pair(s) to an end of the MAC CE and/or RRC message. In some aspects, the UE 120 may autonomously select the number of power headroom estimation pairs included in the transmission (e.g., appended to the end). Accordingly, the UE 120 may indicate the number of power headroom estimation pairs that are included in the transmission.

In some aspects, the UE 120 may implicitly indicate the unscheduled modulation order of a power headroom estimation pair. To illustrate, the UE 120 may implicitly indicate a modulation order based at least in part on a location of the power headroom estimation field within the MAC CE, such as a location and/or position in a list. As another example, the UE 120 may implicitly indicate the modulation order based at least in part on using a transmission configuration (e.g., an MCS) that is associated with the modulation order to transmit the power headroom estimation pair. For example, the UE 120 may generate a transmission based at least in part on using one or more air interface resources that are scheduled for a PUSCH transmission (e.g., via the transmission configuration), but may use a different modulation order for the transmission than a scheduled modulation order (e.g., via the transmission configuration). Accordingly, the UE 120 may explicitly indicate a power headroom estimation, such as by transmitting a value in a bit field, and/or may implicitly indicate an unscheduled modulation order that is associated with the power headroom estimation as described above.

In some aspects, the UE 120 may indicate an absence of a power headroom estimation pair in a transmission by setting a power headroom estimation pair field to a null value. To illustrate, the UE 120 may set one or more bit fields (e.g., a power headroom estimation field and/or an alternative modulation order field) to a value (e.g., “0”) that indicates null.

As shown by reference number 630, the network node 110 may transmit, and the UE 120 may receive, an indication transmission configuration information (e.g., an uplink transmission configuration and/or an updated uplink transmission configuration). In some aspects, the transmission configuration may be based at least in part on a power headroom estimation pair indicated by the UE 120 and as described with regard to reference number 620. As one example, the transmission configuration information may include a transmit power configuration and/or an MCS configuration for an uplink transmission by the UE 120, and the transmit power configuration and/or the MCS configuration may be based at least in part on a power headroom estimation pair.

As shown by reference number 640, the UE 120 may transmit, and the network node 110 may receive, an uplink transmission that is based at least part on the transmission configuration information from the network node 110 as described with regard to reference number 630 and/or a power headroom estimation pair as described with regard to reference number 620. As one example, the UE 120 may transmit a PUSCH transmission based at least in part on using a transmission power level that is associated with a power headroom estimation that is indicated by a power headroom estimation pair as described with regard to reference number 620 and/or based at least in part on a modulation order that is indicated by the power headroom estimation pair. In some aspects, the UE 120 may transmit the uplink transmission based at least in part on receiving an updated transmission configuration that is based at least in part on the power headroom estimation pair. In other aspects, the UE 120 may transmit the uplink transmission based at least in part on modifying a scheduled transmission configuration, such as by using a different modulation order and/or by using a different MCS than indicated by the scheduled transmission configuration.

While FIG. 6 shows the UE 120 transmitting the uplink transmission separately from the power headroom estimation pair(s) in the example 600, other examples may include the UE 120 transmitting the power headroom estimation pair in the uplink transmission. For example, the UE 120 may indicate a power headroom estimation in the uplink transmission (e.g., by transmitting a value in a bit field) and/or may indicate an unscheduled modulation order via the uplink transmission, such as by using an unscheduled modulation order and/or unscheduled MCS to generate the uplink transmission.

By indicating a power headroom estimation pair, a UE may provide a network node with information that enables the network node to recover an uplink transmission that is based at least in part on a UE-specific power boost optimization (e.g., an uplink transmission that uses an unscheduled modulation order) and/or enables the network node to schedule the UE with a UE-specific modulation order that optimizes a power boost for an uplink transmission by the UE. Optimizing the power boost for the uplink transmission may enable the UE to transmit an uplink communication at a higher power level (e.g., relative to an uplink transmission that is based at least in part on a different modulation order) that results in an improved signal quality, reduced recovery errors, reduced data transfer delays, and/or increased data throughput.

As indicated above, FIG. 6 is provided as an example. Other examples may differ from what is described with regard to FIG. 6.

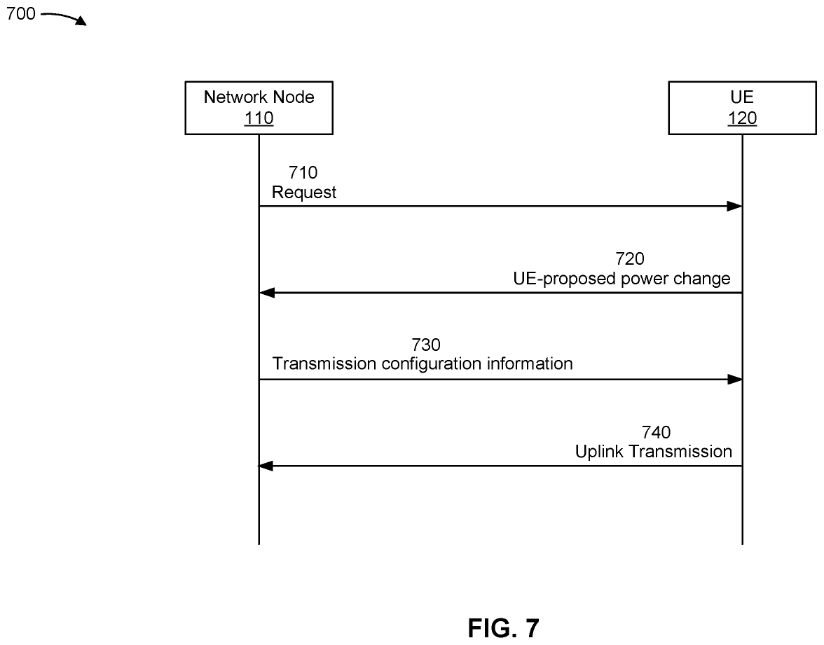

FIG. 7 is a diagram illustrating an example 700 of a wireless communication process between a network node (e.g., the network node 110) and a UE (e.g., the UE 120), in accordance with the present disclosure.

As shown by reference number 710, a network node 110 may transmit, and a UE 120 may receive, one or more instructions that are associated with a UE-proposed power change. As one example, the network node 110 may transmit an instruction that implicitly requests the UE-proposed power change, such as by transmitting a request that explicitly requests UE capability information. That is, the request for UE capability information may implicitly indicate a request to include a UE-proposed power change in the UE capability information. As another example, the network node 110 may transmit an explicit instruction that requests the UE-proposed power change (e.g., separate from the request for UE capability information). The network node 110 may transmit the implicit and/or explicit instruction(s) in Layer 1 signaling (e.g., DCI), Layer 2 signaling (e.g., a MAC CE), and/or Layer 3 signaling (e.g., RRC signaling).

In some aspects, the network node 110 may transmit and/or configure one or more tables associated with the UE-proposed power change via RRC signaling, such as by signaling a respective value for each entry of a table. To illustrate, the network node 110 may transmit any combination of an RRC configured modulation order table that specifies different modulation orders, an RRC configured MCS table that specifies different MCSs, and/or an RRC configured power headroom estimation table that specifies different power headroom estimation values and/or power boost values that may be selected by the UE to indicate the UE-proposed power change.

As shown by reference number 720, the UE 120 may transmit, and the network node 110 may receive, a second indication of the UE-proposed power change, and the UE-proposed power change may indicate a power boosting capability associated with the UE 120. That is, the UE-proposed power change may be UE-specific (e.g., specific to the UE 120) based at least in part on an implementation of the UE and/or optimizations at the UE. In some aspects, the UE 120 may transmit the second indication of the UE-proposed power change in Layer 1 signaling, Layer 2 signaling, and/or Layer 3 signaling. As one example, the UE 120 may transmit an indication of the UE-proposed power change in an RRC message, such as an RRC message that includes UE capability information. As another example, the UE 120 may transmit the indication of the UE-proposed power change in Layer 1 signaling, such as by transmitting the indication in UCI. Alternatively, or additionally, the UE 120 may transmit the indication of the UE-proposed power change in Layer 2 signaling, such as by transmitting the indication in a MAC CE.

In some aspects, the UE-proposed power change may be based at least in part on a power class of the UE. To illustrate, the UE 120 may be associated with and/or classified as a particular power class, and the particular power class may be associated with a nominal transmission power. Accordingly, the UE 120 may calculate the UE-proposed power change based at least in part on the nominal transmission power associated with the power class. For example, the UE 120 may calculate the UE-proposed power change as a power boost that is relative to the nominal transmission power. That is, the UE-proposed power change may be a delta transmission power change and/or an uplink power boost that is relative to the nominal transmission power. In some aspects, the UE 120 may calculate the UE-proposed power change based at least in part on a UE-specific implementation for power boosting, such as a hardware implementation and/or an optimal configuration that is associated with the hardware implementation. To illustrate, the optimal configuration may be based at least in part on an excess gain availability (e.g., that may be hardware dependent and/or frequency dependent, a robustness of a power amplifier (e.g., a noise level), and/or a robustness of a front end component (e.g., a filter switch). For example, the UE may select, as an optimal configuration, a parameter value that improves a transmission performance (e.g., reduces noise, increases an output power level and/or reduces distortion) at the UE based at least in part on a digital to analog converter (DAC) set point, a power amplifier biasing, and/or a non-linearity of a digital pre-distortion (DPD) algorithm.

The UE 120 may calculate the UE-proposed power changed based at least in part on a communication standard. That is, the UE 120 may calculate the UE-proposed power change based at least in part on a value indicated by the communication standard. To illustrate, a communication standard may indicate one or more values (e.g., a fixed value and/or via an inequality equation) that are associated with the UE-proposed power change.

In some aspects, the UE 120 may transmit, as the indication of the UE-proposed power change, a value (e.g., a floating point value or an integer), such as a value that has a unit of decibels (dBs). In other aspects, the UE 120 may transmit a bit pattern and/or index that maps an entry in an RRC configured table.

As shown by reference number 730, the network node 110 may transmit, and the UE 120 may receive, a third indication of a transmission configuration (e.g., an uplink transmission configuration). In some aspects, the transmission configuration may be based at least in part on the UE-proposed power change. For example, the transmission configuration may specify a target transmission power level that is based at least in part on the UE-proposed power change. While FIG. 7 shows the network node 110 transmitting the third indication of the transmission configuration in the example 700, the network node 110 may refrain from transmitting the third indication in other examples.

As shown by reference number 740, the UE 120 may transmit, and the network node 110 may receive, an uplink transmission that is based at least in part on the UE-proposed power change. In some aspects, the UE 120 may transmit the uplink transmission based at least in part on the transmission configuration described with regard to reference number 730.

By indicating a UE-proposed power change, a UE may provide a network node with information that enables the network node to schedule the UE with a target transmission power level that increases uplink power boost for an uplink transmission by the UE. Increasing the power boost for the uplink transmission may enable the UE to transmit an uplink communication at a higher power level, that results in an improved signal quality, reduced recovery errors, reduced data transfer delays, and/or increased data throughput.

As indicated above, FIG. 7 is provided as an example. Other examples may differ from what is described with regard to FIG. 7.

FIG. 8 is a diagram illustrating an example MAC CE 800 that may be used to report a power boost that is associated with an alternative MCS (e.g., unscheduled MCS), in accordance with the present disclosure. In some aspects, the MAC CE 800 shown by FIG. 8 may be a single entry PHR MAC CE that includes one or more power headroom estimation pairs. That is, the MAC CE 800 shown by FIG. 8 may be configured based at least in part on a power headroom estimation pair MAC CE format. In FIG. 8, a horizontal axis represents bits, and the MAC CE 800 includes multiple fields that are grouped into respective octets (e.g., eight bits).

A first octet of bits of the MAC CE 800 may include a power backoff field 802 (shown as P 802) that occupies a single bit of the first octet, a second reserved bit field 804 (shown as R 804) that occupies a single bit of the first octet, and a power headroom field 806 (shown as PH 806) that occupies six bits of the first octet. A UE (e.g., a UE 120) may set the power backoff field 802 to a first value (e.g., “1”) to indicate that a MAC entity at the UE applies power backoff for generating an uplink transmission or to a second value (e.g., “0”) to indicate that the MAC entity does not apply power back off for generating the uplink transmission. Alternatively, or additionally, the UE may set the power headroom field 806 to a value that indicates a power headroom estimation that is associated with a scheduled MCS. In some aspects, the UE may set the power headroom field 806 to a value that is based at least in part on a table and/or a mapping to an entry in the table, such as an index.

A second octet of bits of the MAC CE 800 may include an MPE field 808 (shown as MPE 808) that occupies two bits of the second octet and a configured maximum output power field 810 (shown as P_{CMAX f, c}) that occupies six bits of the second octet. A UE may set the MPE field 808 to a value that indicates an applied power backoff to meet an MPE operating condition (e.g., specified by a communication standard). Alternatively, or additionally, the UE may set the configured maximum output power field 810 to a value that specifies a nominal transmit power level used by the UE to calculate the power headroom indicated in the power headroom field 806. In some aspects, the UE may set the configured maximum output power field 810 to a value that is based at least in part on a table and/or a mapping to an entry in the table.

In some aspects, the MAC CE 800 may include and/or indicate one or more power headroom estimation pairs in additional octets (e.g., additional to the first octet and the second octet). For example, a first additional octet of the MAC CE 800 may include and/or indicate a first power headroom estimation pair 812-1. Alternatively, or additionally, an n-th additional octet of the MAC CE 800 may include and/or indicate an n-th power headroom estimation pair 812-n, where n is an integer. In some aspects, the first power headroom estimation pair 812-1 may include a first alternate modulation order field 814-2 (shown as MCS alt 1 814-1) and a first power headroom estimation field (shown as PH 1 816-1). The first power headroom estimation pair 812-1 may indicate a first unscheduled modulation order (e.g., a first unscheduled MCS) and a respective power headroom estimation that is associated with the first unscheduled modulation order. Alternatively, or additionally, the n-th power headroom estimation pair 812-n may include an n-th alternate modulation order field 814-2 (shown as MCS alt n 814-n) and an n-th power headroom estimation field (shown as PH n 816-n). The n-th power headroom estimation pair 812-n may indicate an n-th unscheduled modulation order (e.g., an n-th unscheduled MCS) and a respective power headroom estimation that is associated with the n-th unscheduled modulation order.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120) performs operations associated with a framework to enable uplink power boosting.

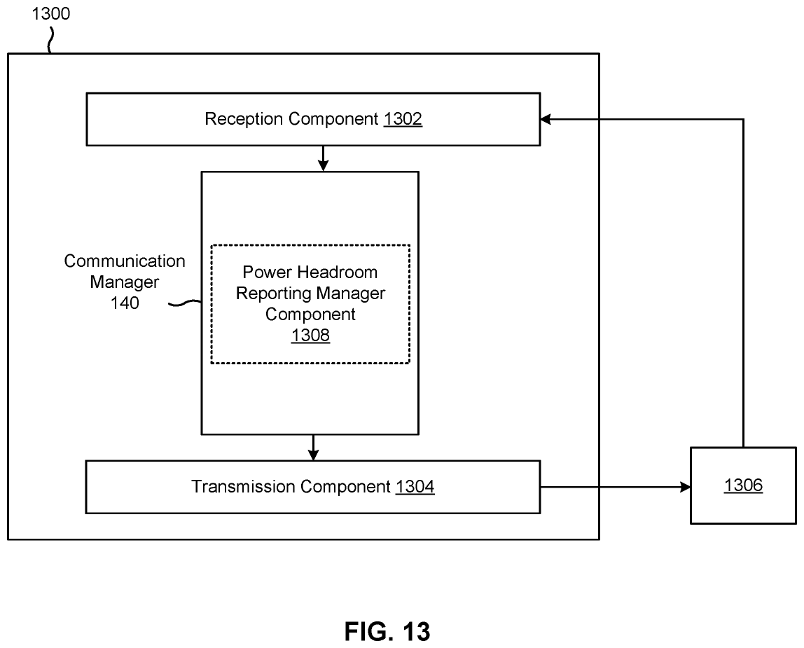

As shown in FIG. 9, in some aspects, process 900 may include transmitting, in Layer 1 or Layer 2 signaling, an indication of at least one power headroom estimation pair that is based at least in part on a power boost for an uplink transmission (block 910). For example, the UE (e.g., using communication manager 140 and/or transmission component 1304, depicted in FIG. 13) may transmit, in Layer 1 or Layer 2 signaling, an indication of at least one power headroom estimation pair that is based at least in part on a power boost for an uplink transmission, as described above. To illustrate, the UE may transmit the indication in a MAC CE or UCI.

As further shown in FIG. 9, in some aspects, process 900 may include transmitting the uplink transmission based at least in part on the power headroom estimation pair (block 920). For example, the UE (e.g., using communication manager 140 and/or transmission component 1304, depicted in FIG. 13) may transmit the uplink transmission based at least in part on the power headroom estimation pair, as described above. To illustrate, the UE may transmit the indication of the power headroom estimation pair in an uplink transmission that is generated based at least in part on an unscheduled modulation order indicated by the power headroom estimation pair.

Process 900 may include additional aspects, such as any single aspect or any combination of aspects described below and/or in connection with one or more other processes described elsewhere herein.

In a first aspect, the at least one power headroom estimation pair comprises a modulation order, and a power headroom estimation that is based at least in part on the modulation order.

In a second aspect, process 900 includes indicating the modulation order based at least in part on indicating an MCS.

In a third aspect, the modulation order comprises at least one of a UE-selected modulation order, a network indicated modulation order, a static modulation order stored at the UE, or a modulation order defined by a communication standard.

In a fourth aspect, the power headroom estimation is based at least in part on an air interface resource assigned to the UE (e.g., a scheduled air interface resource).

In a fifth aspect, process 900 includes indicating, as at least part of the at least one power headroom estimation pair, an absolute power headroom estimation.

In a sixth aspect, process 900 includes indicating, as at least part of the at least one power headroom estimation pair, a delta power headroom estimation (e.g., a difference between a first power headroom for an unscheduled modulation order and a second power headroom associated with a scheduled modulation order).

In a seventh aspect, process 900 includes indicating, as at least part of the at least one power headroom estimation pair, an absolute modulation order or a delta modulation order. For example, a first modulation order (e.g., of a scheduled modulation order) may be associated with a first index value into a table with an order list of MCSs, and a second modulation order (e.g., of an unscheduled modulation order) may be associated with a second index value into the table. In some aspects, a power headroom estimation pair may indicate a delta modulation order that is based at least in part on a difference between the first index value and the second index value.

In an eighth aspect, process 900 includes selecting a number of power headroom estimation pairs to include in the indication, wherein transmitting the indication of the at least one power headroom estimation pair comprises indicating, as the at least one power headroom estimation pair, the number of power headroom estimation pairs.

In a ninth aspect, transmitting the indication comprises transmitting the indication in the Layer 1 signaling, wherein the Layer 1 signaling comprises uplink control information.

In a tenth aspect, transmitting the indication comprises transmitting the indication in the Layer 2 signaling, wherein the Layer 2 signaling comprises a MAC CE.

In an eleventh aspect, the MAC CE is based at least in part on a power headroom estimation pair MAC CE format.

In a twelfth aspect, process 900 includes receiving a radio resource control message that indicates to use the power headroom estimation pair MAC CE format.

In a thirteenth aspect, the power headroom estimation pair MAC CE format comprises a power headroom reporting field that is based at least in part on a first power headroom estimation report associated with a scheduled MCS, and at least one power headroom estimation pair field that is based at least in part on a second power headroom estimation report associated with an unscheduled modulation order.

In a fourteenth aspect, the at least one power headroom estimation pair field is based at least in part on a bit field that includes a power headroom estimation field.

In a fifteenth aspect, the at least one power headroom estimation pair field indicates a modulation order associated with the power headroom estimation field based at least in part on a location of the power headroom estimation field within the MAC CE.

In a sixteenth aspect, the bit field further comprises an alternate modulation order field.

In a seventeenth aspect, the bit field is based at least in part on a mapping.

In an eighteenth aspect, the mapping is configured based at least in part on a RRC message.

In a nineteenth aspect, the at least one power headroom estimation pair field comprises a list of power headroom estimation pair fields.

In a twentieth aspect, process 900 includes setting the at least one power headroom estimation pair field to a null value that indicates an absence of the power headroom estimation pair.

In a twenty-first aspect, the at least one power headroom estimation pair field explicitly indicates the second power headroom estimation report and implicitly indicates the unscheduled modulation order.

In a twenty-second aspect, the at least one power headroom estimation pair field explicitly indicates the second power headroom estimation report and explicitly indicates the unscheduled modulation order.

In a twenty-third aspect, transmitting the indication comprises transmitting the indication based at least in part on using a transmission configuration that is based at least in part on the power headroom estimation pair.

In a twenty-fourth aspect, the transmission configuration is based at least in part on a scheduled transmission configuration, and the transmission configuration is based at least in part on a different modulation order than a modulation order indicated by the scheduled transmission configuration.

In a twenty-fifth aspect, transmitting the indication comprises transmitting the indication based at least in part on using a PUSCH.

In a twenty-sixth aspect, process 900 includes receiving a PUSCH grant that indicates an air interface resource to use for transmitting the indication.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with a framework to enable uplink power boosting.

As shown in FIG. 10, in some aspects, process 1000 may include transmitting an indication of a UE-proposed power change (block 1010). For example, the UE (e.g., using communication manager 140 and/or transmission component 1304, depicted in FIG. 13) may transmit an indication of a UE-proposed power change, as described above.

As further shown in FIG. 10, in some aspects, process 1000 may include transmitting an uplink transmission based at least in part on the UE-proposed power change (block 1020). For example, the UE (e.g., using communication manager 140 and/or transmission component 1304, depicted in FIG. 13) may transmit an uplink transmission based at least in part on the UE-proposed power change, as described above.

Process 1000 may include additional aspects, such as any single aspect or any combination of aspects described below and/or in connection with one or more other processes described elsewhere herein.

In a first aspect, the UE-proposed power change is based at least in part on a power class associated with the UE.

In a second aspect, the UE-proposed power change indicates a change in power that is based least in part on a nominal transmission power associated with the power class.

In a third aspect, the UE-proposed power change includes a UE-specific UE-proposed power change that is based at least in part on a power boosting capability of the UE.

In a fourth aspect, process 1000 includes receiving a transmission configuration that indicates a transmission power level that is based at least in part on the UE-proposed power change.

In a fifth aspect, transmitting the uplink transmission includes transmitting the uplink transmission based at least in part on the transmission configuration.

In a sixth aspect, the transmission configuration indicates an MCS that is based at least in part on the UE-proposed power change, and transmitting the uplink transmission includes transmitting the uplink transmission based at least in part on using the MCS.

In a seventh aspect, transmitting the indication of the UE-proposed power change includes transmitting the indication in UE capability information.

In an eighth aspect, transmitting the indication of the UE-proposed power change includes transmitting the indication in Layer 1 signaling or Layer 2 signaling.

In a ninth aspect, transmitting the indication includes transmitting the indication in the Layer 1 signaling, and the Layer 1 signaling includes UCI.

In a tenth aspect, transmitting the indication includes transmitting the indication in the Layer 2 signaling, and the Layer 2 signaling includes a MAC CE.

In an eleventh aspect, transmitting the indication of the UE-proposed power change includes transmitting the indication in an RRC message.

In a twelfth aspect, a value associated with the UE-proposed power change is based at least in part on a communication standard.

In a thirteenth aspect, transmitting the indication of the UE-proposed power change includes transmitting a value.

In a fourteenth aspect, transmitting the indication of the UE-proposed power change includes transmitting a bit pattern that maps to a value.

In a fifteenth aspect, receiving the indication of the UE-proposed power change includes receiving the indication in UE capability information.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with a framework to enable uplink power boosting.

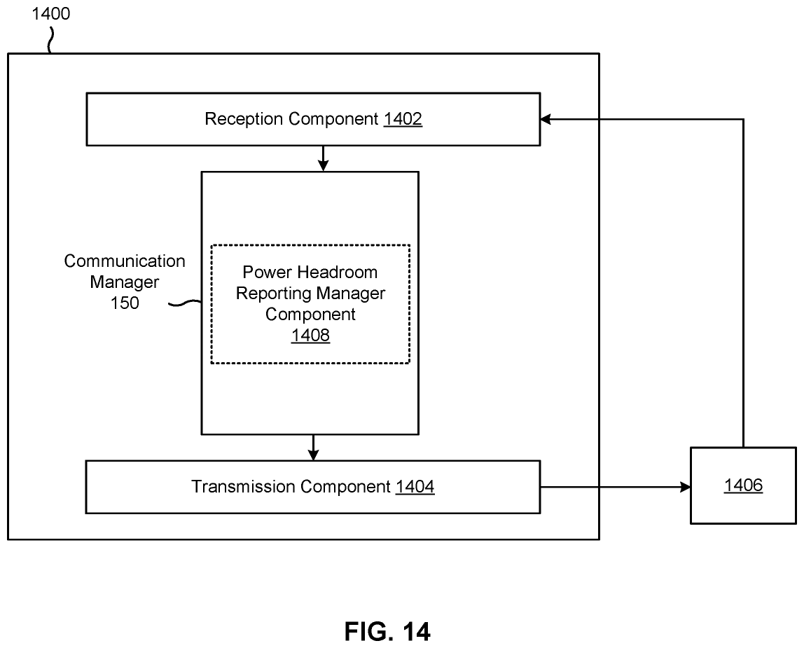

As shown in FIG. 11, in some aspects, process 1100 may include receiving an indication of a UE-proposed power change (block 1110). For example, the network node (e.g., using communication manager 150 and/or reception component 1402, depicted in FIG. 14) may receive an indication of a UE-proposed power change, as described above.

As further shown in FIG. 11, in some aspects, process 1100 may include transmitting an indication of a scheduled power level that is based at least in part on the UE-proposed power change (block 1120). For example, the network node (e.g., using communication manager 150 and/or transmission component 1404, depicted in FIG. 14) may transmit an indication of a scheduled power level that is based at least in part on the UE-proposed power change, as described above.

Process 1100 may include additional aspects, such as any single aspect or any combination of aspects described below and/or in connection with one or more other processes described elsewhere herein.

In a first aspect, the UE-proposed power change is based at least in part on a power class associated with a UE.

In a second aspect, the UE-proposed power change indicates a change in power that is based least in part on a nominal transmission power associated with the power class.

In a third aspect, process 1100 includes calculating the scheduled power level based at least in part on the UE-proposed power change, and transmitting a transmission configuration that is associated with the uplink transmission and indicates the scheduled power level.

In a fourth aspect, process 1100 includes selecting an MCS based at least in part on the UE-proposed power change, and indicating the MCS in the transmission configuration that is associated with the uplink transmission.

In a fifth aspect, receiving the indication of the UE-proposed power change includes receiving the indication in Layer 1 signaling or Layer 2 signaling.

In a sixth aspect, receiving the indication includes receiving the indication in the Layer 1 signaling, and the Layer 1 signaling includes UCI.

In a seventh aspect, receiving the indication includes receiving the indication in the Layer 2 signaling, and the Layer 2 signaling includes a MAC CE.

In an eighth aspect, receiving the indication of the UE-proposed power change includes receiving the indication in an RRC message.

In a ninth aspect, receiving the indication of the UE-proposed power change includes receiving a value.

In a tenth aspect, receiving the indication of the UE-proposed power change includes receiving a bit pattern that maps to a value.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with a framework to enable uplink power boosting.

As shown in FIG. 12, in some aspects, process 1200 may include receiving, in Layer 1 or Layer 2 signaling, an indication of at least one power headroom estimation pair that is based at least in part on a power boost for an uplink transmission (block 1210). For example, the network node (e.g., using communication manager 150 and/or reception component 1402, depicted in FIG. 14) may receive, in Layer 1 signaling or Layer 2 signaling, an indication of at least one power headroom estimation pair that is based at least in part on a power boost for an uplink transmission, as described above.

As further shown in FIG. 12, in some aspects, process 1200 may include receiving the uplink transmission based at least in part on the power headroom estimation pair (block 1220). For example, the network node (e.g., using communication manager 150 and/or reception component 1402, depicted in FIG. 14) may receive the uplink transmission based at least in part on the power headroom estimation pair, as described above.

Process 1200 may include additional aspects, such as any single aspect or any combination of aspects described below and/or in connection with one or more other processes described elsewhere herein.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include a power headroom reporting manager component 1308, among other examples.

In some aspects, the apparatus 1300 may be configured to perform one or more operations described herein in connection with FIGS. 5 and 6. Additionally, or alternatively, the apparatus 1300 may be configured to perform one or more processes described herein, such as process 900 of FIG. 9, process 1000 of FIG. 10, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The power headroom reporting manager component 1308 may transmit, by way of the transmission component 1304 and in Layer 1 signaling or Layer 2 signaling, an indication of at least one power headroom estimation pair that is based at least in part on a power boost for an uplink transmission. The transmission component 1304 may transmit the uplink transmission based at least in part on the power headroom estimation pair. Examples of Layer 1 signaling or Layer 2 signaling include UCI and/or a MAC CE.

The power headroom reporting manager component 1308 may indicate the modulation order based at least in part on indicating a MCS. Alternatively or additionally, the power headroom reporting manager component 1308 may indicate, as at least part of the at least one power headroom estimation pair, an absolute power headroom estimation. In some aspects, the power headroom reporting manager component 1308 may indicate, as at least part of the at least one power headroom estimation pair, a delta power headroom estimation.

The power headroom reporting manager component 1308 may indicate, as at least part of the at least one power headroom estimation pair, an absolute modulation order. Alternatively or additionally, the power headroom reporting manager component 1308 may indicate, as at least part of the at least one power headroom estimation pair, a delta modulation order

The power headroom reporting manager component 1308 may select a number of power headroom estimation pairs to include in the indication. Alternatively or additionally, the power headroom reporting manager component 1308 may set the at least one power headroom estimation pair field to a null value that indicates an absence of the power headroom estimation pair.

The power headroom reporting manager component 1308 may receive, by way of the reception component 1302, a RRC message that indicates to use a power headroom estimation pair MAC CE format. Alternatively or additionally, the power headroom reporting manager component 1308 may receive, by way of the reception component 1302, a PUSCH grant that indicates an air interface resource to use for transmitting the indication.

In some aspects, the power headroom reporting manager component 1308 may transmit, by way of the transmission component 1304, an indication of a UE-proposed power change. The power headroom reporting manager component 1308 may transmit, by way of the transmission component 1304, an uplink transmission based at least in part on the UE-proposed power change.

The power headroom reporting manager component 1308 may receive, by way of the reception component 1302, a transmission configuration that indicates at least one of a transmission power level that is based at least in part on the UE-proposed power change, or a MCS that is based at least in part on the UE-proposed power change.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150) may include a power headroom manager component 1408, among other examples.

In some aspects, the apparatus 1400 may be configured to perform one or more operations described herein in connection with FIGS. 7 and 8. Additionally, or alternatively, the apparatus 1400 may be configured to perform one or more processes described herein, such as process 1100 of FIG. 11, process 1200 of FIG. 12, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The power headroom manager component 1408 may receive, by way of the reception component 1402, an indication of a UE-proposed power change. The power headroom manager component 1408 may transmit, by way of the transmission component 1404, an indication of a scheduled power level that is based at least in part on the UE-proposed power change.

The power headroom manager component 1408 may receive, by way of the reception component 1402 and in Layer 1 or Layer 2 signaling, an indication of at least one power headroom estimation pair that is based at least in part on a power boost for an uplink transmission. The power headroom manager component 1408 may receive, by way of the reception component 1402, the uplink transmission based at least in part on the power headroom estimation pair.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: transmitting, in Layer 1 or Layer 2 signaling, an indication of at least one power headroom estimation pair that is based at least in part on a power boost for an uplink transmission; and transmitting the uplink transmission based at least in part on the power headroom estimation pair.

Aspect 2: The method of Aspect 1, wherein the at least one power headroom estimation pair comprises: a modulation order, and a power headroom estimation that is based at least in part on the modulation order.

Aspect 3: The method of Aspect 2, further comprising: indicating the modulation order based at least in part on indicating a modulation coding scheme (MCS).

Aspect 4: The method of Aspect 2, wherein the modulation order comprises at least one of a UE-selected modulation order, a network indicated modulation order, a static modulation order stored at the UE, or a modulation order defined by a communication standard.

Aspect 5: The method of Aspect 2, wherein the power headroom estimation is based at least in part on an air interface resource assigned to the UE.

Aspect 6: The method of any of Aspects 1-5, further comprising: indicating, as at least part of the at least one power headroom estimation pair, an absolute power headroom estimation.

Aspect 7: The method of any of Aspects 1-6, further comprising: indicating, as at least part of the at least one power headroom estimation pair, a delta power headroom estimation.

Aspect 8: The method of any of Aspects 1-7, further comprising: indicating, as at least part of the at least one power headroom estimation pair, an absolute modulation order or a delta modulation order.

Aspect 9: The method of any of Aspects 1-8, further comprising: selecting a number of power headroom estimation pairs to include in the indication, wherein transmitting the indication of the at least one power headroom estimation pair comprises: indicating, as the at least one power headroom estimation pair, the number of power headroom estimation pairs. wherein transmitting the indication of the at least one power headroom estimation pair comprises: indicating, as the at least one power headroom estimation pair, the number of power headroom estimation pairs.

Aspect 10: The method of any of Aspects 1-9, wherein transmitting the indication comprises: transmitting the indication in the Layer 1 signaling, wherein the Layer 1 signaling comprises uplink control information.

Aspect 11: The method of any of Aspects 1-10, wherein transmitting the indication comprises: transmitting the indication in the Layer 2 signaling, wherein the Layer 2 signaling comprises a medium access control (MAC) control element (CE).

Aspect 12: The method of Aspect 11, wherein the MAC CE is based at least in part on a power headroom estimation pair MAC CE format.

Aspect 13: The method of Aspect 12, further comprising: receiving a radio resource control message that indicates to use the power headroom estimation pair MAC CE format.

Aspect 14: The method of Aspect 12, wherein the power headroom estimation pair MAC CE format comprises: a power headroom reporting field that is based at least in part on a first power headroom estimation report associated with a scheduled modulation and coding scheme (MCS), and at least one power headroom estimation pair field that is based at least in part on a second power headroom estimation report associated with an unscheduled modulation order.

Aspect 15: The method of Aspect 14, wherein the at least one power headroom estimation pair field is based at least in part on a bit field that includes a power headroom estimation field.

Aspect 16: The method of Aspect 15, wherein the at least one power headroom estimation pair field indicates a modulation order associated with the power headroom estimation field based at least in part on a location of the power headroom estimation field within the MAC CE.

Aspect 17: The method of Aspect 15, wherein the bit field further comprises an alternate modulation order field.

Aspect 18: The method of Aspect 15, wherein the bit field is based at least in part on a mapping.

Aspect 19: The method of Aspect 18, wherein the mapping is configured based at least in part on a radio resource control (RRC) message.

Aspect 20: The method of Aspect 14, wherein the at least one power headroom estimation pair field comprises a list of power headroom estimation pair fields.

Aspect 21: The method of Aspect 14, further comprising: setting the at least one power headroom estimation pair field to a null value that indicates an absence of the power headroom estimation pair.

Aspect 22: The method of Aspect 14, wherein the at least one power headroom estimation pair field explicitly indicates the second power headroom estimation report and implicitly indicates the unscheduled modulation order.

Aspect 23: The method of Aspect 14, wherein the at least one power headroom estimation pair field explicitly indicates the second power headroom estimation report and explicitly indicates the unscheduled modulation order.

Aspect 24: The method of any of Aspects 1-23, wherein transmitting the indication comprises: transmitting the indication based at least in part on using a transmission configuration that is based at least in part on the power headroom estimation pair.

Aspect 25: The method of Aspect 24, wherein the transmission configuration is based at least in part on a scheduled transmission configuration, and wherein the transmission configuration is based at least in part on a different modulation order than a modulation order indicated by the scheduled transmission configuration.

Aspect 26: The method of any of Aspects 1-25, wherein transmitting the indication comprises: transmitting the indication based at least in part on using a physical uplink shared channel (PUSCH).

Aspect 27: The method of Aspect 26, further comprising: receiving a PUSCH grant that indicates an air interface resource to use for transmitting the indication.

Aspect 28: A method of wireless communication performed by a network node, comprising: receiving, in Layer 1 or Layer 2 signaling, an indication of at least one power headroom estimation pair that is based at least in part on a power boost for an uplink transmission; and receiving the uplink transmission based at least in part on the power headroom estimation pair.

Aspect 29: A method of wireless communication performed by a user equipment (UE), comprising: transmitting an indication of a UE-proposed power change; and transmitting an uplink transmission based at least in part on the UE-proposed power change.

Aspect 30: The method of Aspect 29, wherein the UE-proposed power change is based at least in part on a power class associated with the UE.

Aspect 31: The method of Aspect 30, wherein the UE-proposed power change indicates a change in power that is based least in part on a nominal transmission power associated with the power class.

Aspect 32: The method of Aspect 31, wherein the UE-proposed power change comprises a UE-specific UE-proposed power change that is based at least in part on a power boosting capability of the UE.

Aspect 33: The method of any of Aspects 29-32, further comprising: receiving a transmission configuration that indicates a transmission power level that is based at least in part on the UE-proposed power change.

Aspect 34: The method of Aspect 33, wherein transmitting the uplink transmission comprises: transmitting the uplink transmission based at least in part on the transmission configuration.

Aspect 35: The method of Aspect 34, wherein the transmission configuration indicates a modulation coding scheme (MCS) that is based at least in part on the UE-proposed power change, and wherein transmitting the uplink transmission comprises: transmitting the uplink transmission based at least in part on using the MCS.

Aspect 36: The method of any of Aspects 29-35, wherein transmitting the indication of the UE-proposed power change comprises: transmitting the indication in UE capability information.

Aspect 37: The method of any of Aspects 29-36, wherein transmitting the indication of the UE-proposed power change comprises: transmitting the indication in Layer 1 signaling or Layer 2 signaling.

Aspect 38: The method of Aspect 37, wherein transmitting the indication comprises transmitting the indication in the Layer 1 signaling, wherein the Layer 1 signaling comprises uplink control information (UCI).

Aspect 39: The method of Aspect 37, wherein transmitting the indication comprises transmitting the indication in the Layer 2 signaling, wherein the Layer 2 signaling comprises a medium access control (MAC) control element (CE).

Aspect 40: The method of any of Aspects 29-39, wherein transmitting the indication of the UE-proposed power change comprises: transmitting the indication in a radio resource control (RRC) message.

Aspect 41: The method of any of Aspects 29-40, wherein a value associated with the UE-proposed power change is based at least in part on a communication standard.

Aspect 42: The method of any of Aspects 29-41, wherein transmitting the indication of the UE-proposed power change comprises: transmitting a value.

Aspect 43: The method of any of Aspects 29-42, wherein transmitting the indication of the UE-proposed power change comprises: transmitting a bit pattern that maps to a value.

Aspect 44: A method of wireless communication performed by a network node, comprising: receiving an indication of a user equipment (UE)-proposed power change that is associated with an uplink transmission; and transmitting an indication of a scheduled power level for the uplink transmission, the scheduled power level being based at least in part on the UE-proposed power change.

Aspect 45: The method of Aspect 44, wherein the UE-proposed power change is based at least in part on a power class associated with a UE.

Aspect 46: The method of Aspect 45, wherein the UE-proposed power change indicates a change in power that is based least in part on a nominal transmission power associated with the power class.

Aspect 47: The method of any of Aspects 44-46, further comprising: calculating the scheduled power level based at least in part on the UE-proposed power change; and transmitting a transmission configuration that is associated with the uplink transmission and indicates the scheduled power level.

Aspect 48: The method of Aspect 47, further comprising: selecting a modulation coding scheme (MCS) based at least in part on the UE-proposed power change, and indicating the MCS in the transmission configuration that is associated with the uplink transmission.

Aspect 49: The method of Aspect 44, wherein receiving the indication of the UE-proposed power change comprises: receiving the indication in UE capability information.

Aspect 50: The method of any of Aspects 44-49, wherein receiving the indication of the UE-proposed power change comprises: receiving the indication in Layer 1 signaling or Layer 2 signaling.

Aspect 51: The method of Aspect 50, wherein receiving the indication comprises receiving the indication in the Layer 1 signaling, and wherein the Layer 1 signaling comprises uplink control information (UCI).

Aspect 52: The method of Aspect 50, wherein receiving the indication comprises receiving the indication in the Layer 2 signaling, and wherein the Layer 2 signaling comprises a medium access control (MAC) control element (CE).

Aspect 53: The method of any of Aspects 44-52, wherein receiving the indication of the UE-proposed power change comprises: receiving the indication in a radio resource control (RRC) message.

Aspect 54: The method of any of Aspects 44-53, wherein receiving the indication of the UE-proposed power change comprises: receiving a value.

Aspect 55: The method of any of Aspects 44-54, wherein receiving the indication of the UE-proposed power change comprises: receiving a bit pattern that maps to a value.

Aspect 56: An apparatus for wireless communication at a device, comprising one or more processors; memory coupled with the one or more processors; and instructions stored in the memory and executable by the one or more processors to, individually or collectively, cause the apparatus to perform the method of one or more of Aspects 1-27 and/or Aspects 29-43.

Aspect 57: An apparatus for wireless communication at a device, comprising one or more processors; memory coupled with the one or more processors; and instructions stored in the memory and executable by the one or more processors to, individually or collectively, cause the apparatus to perform the method of one or more of Aspect 28 and/or Aspects 44-55.

Aspect 58: A device for wireless communication, comprising a memory and one or more processors coupled to the memory, the one or more processors configured to, individually or collectively, perform the method of one or more of Aspects 1-27 and/or Aspects 29-43.

Aspect 59: A device for wireless communication, comprising a memory and one or more processors coupled to the memory, the one or more processors configured to, individually or collectively, perform the method of one or more of Aspect 28 and/or Aspects 44-55.

Aspect 60: An apparatus for wireless communication, comprising at least one means for performing the method of one or more of Aspects 1-27 and/or Aspects 29-43.

Aspect 61: An apparatus for wireless communication, comprising at least one means for performing the method of one or more of Aspect 28 and/or Aspects 44-55.

Aspect 62: A non-transitory computer-readable medium storing code for wireless communication, the code comprising instructions executable by a processor to perform the method of one or more of Aspects 1-27 and/or Aspects 29-43.

Aspect 63: A non-transitory computer-readable medium storing code for wireless communication, the code comprising instructions executable by a processor to perform the method of one or more of Aspect 28 and/or Aspects 44-55.

Aspect 64: A non-transitory computer-readable medium storing a set of instructions for wireless communication, the set of instructions comprising one or more instructions that, when executed by one or more processors of a device, cause the device to perform the method of one or more of Aspects 1-27 and/or Aspects 29-43.

Aspect 65: A non-transitory computer-readable medium storing a set of instructions for wireless communication, the set of instructions comprising one or more instructions that, when executed by one or more processors of a device, cause the device to perform the method of one or more of Aspect 28 and/or Aspects 44-55.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, that are individually or collectively configured to:
transmit an indication of a UE-proposed power change; and
transmit an uplink transmission based at least in part on the UE-proposed power change.

2. The apparatus of claim 1, wherein the UE-proposed power change is based at least in part on a power class associated with the UE.

3. The apparatus of claim 2, wherein the UE-proposed power change indicates a change in power that is based least in part on a nominal transmission power associated with the power class.

4. The apparatus of claim 3, wherein the UE-proposed power change comprises a UE-specific UE-proposed power change that is based at least in part on a power boosting capability of the UE.

5. The apparatus of claim 1, wherein the one or more processors, individually or collectively, are further configured to:
receive a transmission configuration that indicates a transmission power level that is based at least in part on the UE-proposed power change.

6. The apparatus of claim 5, wherein the one or more processors, to transmit the uplink transmission, are configured, individually or collectively, to:
transmit the uplink transmission based at least in part on the transmission configuration.

7. The apparatus of claim 1, wherein the one or more processors, to transmit the indication of the UE-proposed power change, are configured, individually or collectively, to:
transmit the indication in UE capability information.

8. The apparatus of claim 1, wherein the one or more processors, to transmit the indication of the UE-proposed power change, are configured, individually or collectively, to:
transmit the indication in Layer 1 signaling or Layer 2 signaling.

9. The apparatus of claim 8, wherein the one or more processors are configured, individually or collectively, to transmit the indication in the Layer 1 signaling, and
wherein the Layer 1 signaling comprises uplink control information (UCI).

10. The apparatus of claim 8, wherein the one or more processors, to transmit the indication, are configured, individually or collectively, to transmit the indication in the Layer 2 signaling,
wherein the Layer 2 signaling comprises a medium access control (MAC) control element (CE).

11. The apparatus of claim 1, wherein the one or more processors, to transmit the indication of the UE-proposed power change, are configured, individually or collectively, to:
transmit the indication in a radio resource control (RRC) message.

12. The apparatus of claim 1, wherein a value associated with the UE-proposed power change is based at least in part on a communication standard.

13. The apparatus of claim 1, wherein the one or more processors, to transmit the indication of the UE-proposed power change, are configured, individually or collectively, to:
transmit a value.

14. The apparatus of claim 1, wherein the one or more processors, to transmit the indication of the UE-proposed power change, are configured, individually or collectively, to:
transmit a bit pattern that maps to a value.

15. The apparatus of claim 1, wherein the one or more processors, to receive the indication of the UE-proposed power change, are configured, individually or collectively, to:
receive the indication in UE capability information.

16. An apparatus for wireless communication at a network node, comprising:
a memory; and
one or more processors, coupled to the memory, that are individually or collectively configured to:
receive an indication of a user equipment (UE)-proposed power change that is associated with an uplink transmission; and
transmit an indication of a scheduled power level for the uplink transmission, the scheduled power level being based at least in part on the UE-proposed power change.

17. The apparatus of claim 16, wherein the UE-proposed power change is based at least in part on a power class associated with a UE.

18. The apparatus of claim 17, wherein the UE-proposed power change indicates a change in power that is based least in part on a nominal transmission power associated with the power class.

19. The apparatus of claim 16, wherein the one or more processors are further configured, individually or collectively, to:
calculate the scheduled power level based at least in part on the UE-proposed power change; and
transmit a transmission configuration that is associated with the uplink transmission and indicates the scheduled power level.

20. The apparatus of claim 16, wherein the one or more processors, to receive the indication of the UE-proposed power change, are configured, individually or collectively, to:
receive the indication in Layer 1 signaling or Layer 2 signaling.

21. The apparatus of claim 20, wherein the one or more processors are configured, individually or collectively, to receive the indication in the Layer 1 signaling, and
wherein the Layer 1 signaling comprises uplink control information (UCI).

22. The apparatus of claim 20, wherein the one or more processors, to receive the indication, are configured, individually or collectively, to receive the indication in the Layer 2 signaling, and
wherein the Layer 1 signaling comprises a medium access control (MAC) control element (CE).

23. The apparatus of claim 16, wherein the one or more processors, to receive the indication of the UE-proposed power change, are configured, individually or collectively, to:
receive the indication in a radio resource control (RRC) message.

24. The apparatus of claim 16, wherein the one or more processors, to receive the indication of the UE-proposed power change, are configured, individually or collectively, to:
receive a value.

25. The apparatus of claim 16, wherein the one or more processors, to receive the indication of the UE-proposed power change, are configured, individually or collectively, to:
receive a bit pattern that maps to a value.

26. A method of wireless communication performed by a user equipment (UE), comprising:
transmitting an indication of a UE-proposed power change; and
transmitting an uplink transmission based at least in part on the UE-proposed power change.

27. The method of claim 26, wherein the UE-proposed power change is based at least in part on a power class associated with the UE.

28. The method of claim 27, wherein the UE-proposed power change indicates a change in power that is based least in part on a nominal transmission power associated with the power class.

29. A method of wireless communication performed by a network node, comprising:
receiving an indication of a user equipment (UE)-proposed power change that is associated with an uplink transmission; and
transmitting an indication of a scheduled power level for the uplink transmission, the scheduled power level being based at least in part on the UE-proposed power change.

30. The method of claim 29, wherein the UE-proposed power change is based at least in part on a power class associated with a UE, and
wherein the UE-proposed power change indicates a change in power that is based at least in part on a nominal transmission power associated with the power class.
